(19) United States
(12) Patent Application Publication
(10) Pub. No.: US 2016/0004444 A1
(43) Pub. Date: Jan. 7, 2016

(54) METHOD AND APPARATUS FOR APPLYING STORAGE FUNCTIONALITY TO EACH SUBSIDIARY VOLUME

(71) Applicant: HITACHI, LTD., Chiyoda-ku, Tokyo (JP)

(72) Inventor: Akio NAKAJIMA, Santa Clara, CA (US)

(21) Appl. No.: 14/768,774

(22) PCT Filed: Jul. 10, 2013
(86) PCT No.: PCT/US2013/049845

§ 371 Date: Aug. 19, 2015

(51) Int. Cl. G06F 3/06

(52) U.S. Cl. CPC G06F 3/0604; G06F 3/0644; G06F 3/0683

(57) ABSTRACT

Exemplary embodiments apply storage functionality to a subsidiary volume of a logical unit group. In one aspect, a storage system comprises a plurality of storage devices to store data, and a controller operable to manage a plurality of logical volumes, each of which is a unit for setting a storage function. The controller is operable to manage a logical unit group, which is mapped to one of the logical volumes and includes an administrative logical unit and one or more subsidiary logical units. The controller is operable to manage a virtual logical unit group which includes a plurality of virtual subsidiary logical units and a virtual administrative logical unit that is mapped to the administrative logical unit, each of which is provided to one of a plurality of virtual machines of a server, at least one virtual subsidiary logical unit being mapped to the one or more subsidiary logical units.

### BACKGROUND OF THE INVENTION

The present invention relates generally to computer systems, storage systems, server virtualization, and storage volume virtualization. More particularly, it relates to method and apparatus for applying storage functionality to a subsidiary volume of a logical unit group.

According to the latest SCSI (Small computer system interface) specification, a LU (Logical Unit) Group is defined. The LU Group includes an administrative LU and multiple subsidiary LUs. A conventional LU contains the LU Group which has multiple subsidiary LUs. The administrative LU of the LU Group is a management LU to create, delete, migrate, or control the subsidiary LUs in the LU Group.

A storage array has some storage functionalities such as local copy, snapshot, thin provisioning, remote copy, and so on. These storage functionalities are applied in units of conventional LU.

When a conventional LU which contains a LU Group is applied some storage functionalities, all of the subsidiary LUs inherit the same storage functionalities. As a result, administrators could not apply some other storage functionalities to a subsidiary LU of the LU Group. Also, when a subsidiary LU is migrated to a destination LU Group, the applied storage functionality of that subsidiary LU is changed to some other storage functionality, when the destination LU Group is applied a different storage functionality configuration.

### BRIEF SUMMARY OF THE INVENTION

Exemplary embodiments of the invention provide a way to apply storage functionality to a subsidiary volume of a LU Group. A storage array has a program for LU Group management. The storage array has a virtual LU group with mapped pointer between subsidiary LU number of physical LU Group and subsidiary LU number of virtual LU Group. The storage array has mapping pointer from virtual subsidiary LU number to physical subsidiary LU number.

When an administrator creates a new LU Group with one administrative LU without any subsidiary LU, then the program of the storage array creates virtual LU Group and physical LU Group respectively.

When the administrator creates a new subsidiary LU with a storage functionality to the LU Group with no subsidiary LU, then (1) the storage array program instructs the virtual administrative LU to create virtual subsidiary LU in the virtual LU Group, then (2) the storage array program instructs the physical administrative LU to create physical subsidiary LU in the physical LU Group, and then (3) the storage array program creates mapping pointer from the virtual subsidiary LU in the virtual LU Group to physical subsidiary LU in the physical LU Group.

When the administrator creates a new subsidiary LU with a different storage functionality to the LU Group with the created subsidiary LU, then (1) the storage array program creates a new physical LU Group, (2) the storage array program instructs the first virtual administrative LU to create second virtual subsidiary LU in the first virtual LU Group, then (3) the storage array program instructs the second physical administrative LU to create second physical subsidiary LU in the second physical LU Group, and then (4) the storage array program creates mapping pointer from the second virtual subsidiary LU in the first virtual LU Group to the second physical subsidiary LU in the second physical LU Group.

The administrator could apply storage functionality to each subsidiary LUs of the LU Group, respectively, although the LU Group contains physical LU in the storage array.

In accordance with an aspect of the present invention, a storage system comprises a plurality of storage devices to store data, and a controller operable to manage a plurality of logical volumes, each of which is a unit for setting a storage function. The controller is operable to manage a logical unit group, which is mapped to one of the logical volumes and includes an administrative logical unit and one or more subsidiary logical units. The controller is operable to manage a virtual logical unit group which includes a plurality of virtual subsidiary logical units and a virtual administrative logical unit that is mapped to the administrative logical unit, each of which is provided to one of a plurality of virtual machines of a server, at least one virtual subsidiary logical unit being mapped to the one or more subsidiary logical units.

In some embodiments, the plurality of virtual subsidiary logical units include a first virtual subsidiary logical unit and a second virtual subsidiary logical unit. The first virtual subsidiary logical unit is mapped to a first subsidiary logical unit of a first logical unit group that is mapped to a first logical volume of the plurality of logical volumes. The second virtual subsidiary logical unit is mapped to either a second subsidiary logical unit of a second logical unit group that is mapped to a second logical volume of the plurality of logical volumes or to another one of the plurality of logical volumes.

In specific embodiments, the storage system comprises a first logical unit group that is mapped to a first logical volume of the plurality of logical volumes, and a second logical unit group that is mapped to a second logical volume of the plurality of logical volumes, the second logical volume having a different storage function from the first logical volume. The plurality of virtual subsidiary logical units include a first virtual subsidiary logical unit which is initially mapped to a first subsidiary logical unit of the first logical unit group. The controller is operable to migrate data of the first subsidiary logical unit to a second subsidiary logical unit of the second logical unit group, delete mapping of the first virtual subsidiary logical unit to the first subsidiary logical unit, and create mapping of the first virtual subsidiary logical unit to the second subsidiary logical unit. The controller is operable to delete the first subsidiary logical unit in the first logical unit group, determine whether there is any remaining subsidiary logical unit in the first logical unit group, and, if there is no remaining subsidiary logical unit in the first logical unit group, then delete the first logical unit group.

In some embodiments, the storage system comprises a first virtual logical unit group having a first virtual administrative logical unit that is mapped to a first administrative logical unit of a first logical unit group that is mapped to a first logical volume of the plurality of logical volumes, and a second virtual logical unit group having a second virtual administrative logical unit that is mapped to a second administrative logical unit of a second logical unit group that is mapped to a second logical volume of the plurality of logical volumes, the second logical volume having a different storage function from the first logical volume. The first virtual subsidiary logical unit has a first virtual subsidiary logical unit which is initially mapped to a first subsidiary logical unit of the first logical unit group. The controller is operable to bind the first virtual subsidiary logical unit of the first virtual logical unit group to a second virtual subsidiary logical unit of the second virtual logical unit group, delete mapping of the first virtual subsidiary logical unit to the first subsidiary logical unit, and create mapping of the second virtual subsidiary logical unit to the first subsidiary logical unit.

In specific embodiments, the storage system comprises a first virtual logical unit group having a first virtual administrative logical unit that is mapped to a first administrative logical unit of a first logical unit group that is mapped to a first logical volume of the plurality of logical volumes, and a second virtual logical unit group having a second virtual administrative logical unit that is mapped to a second administrative logical unit of a second logical unit group that is mapped to a second logical volume of the plurality of logical volumes, the second logical volume having a different storage function from the first logical volume. The first virtual subsidiary logical unit has a first virtual subsidiary logical unit which is initially mapped to a first subsidiary logical unit of the first logical unit group. The controller is operable to: bind the first virtual subsidiary logical unit of the first virtual logical unit group to a second virtual subsidiary logical unit of the second virtual logical unit group; migrate data of the first subsidiary logical unit to a third subsidiary logical unit of a third logical unit group which is mapped to a third logical volume of the plurality of logical volumes, the third logical volume having a same storage function as the first logical volume; delete mapping of the first virtual subsidiary logical unit to the first subsidiary logical unit; and create mapping of the second virtual subsidiary logical unit to the third subsidiary logical unit.

In some embodiments, the storage system comprises a first virtual logical unit group having a first virtual administrative logical unit that is mapped to a first administrative logical unit of a first logical unit group that is mapped to a first logical volume of the plurality of logical volumes, and a second virtual logical unit group having a second virtual administrative logical unit that is mapped to a second administrative logical unit of a second logical unit group that is mapped to a second logical volume of the plurality of logical volumes, the second logical volume having a different storage function from the first logical volume. The first virtual subsidiary logical unit has a first virtual subsidiary logical unit which is initially mapped to a first subsidiary logical unit of the first logical unit group. The controller is operable to: bind the first virtual subsidiary logical unit of the first virtual logical unit group to a second virtual subsidiary logical unit of the second virtual logical unit group; migrate data of the first subsidiary logical unit to a second subsidiary logical unit of the second logical unit group; delete mapping of the first virtual subsidiary logical unit to the first subsidiary logical unit; and create mapping of the second virtual subsidiary logical unit to the second subsidiary logical unit.

In specific embodiments, the storage system comprises a first virtual logical unit group having a first virtual administrative logical unit that is mapped to a first administrative logical unit of a first logical unit group that is mapped to a first logical volume of the plurality of logical volumes; a second virtual logical unit group having a second virtual administrative logical unit that is mapped to a second administrative logical unit of a second logical unit group that is mapped to a second logical volume of the plurality of logical volumes, the second logical volume having a same storage function as the first logical volume; and a third virtual logical unit group having a third virtual administrative logical unit that is mapped to a third administrative logical unit of a third logical unit group that is mapped to a third logical volume of the plurality of logical volumes, the third logical volume having a different storage function from the first logical volume. The first virtual subsidiary logical unit has a first virtual subsidiary logical unit which is initially mapped to a first subsidiary logical unit of the first logical unit group. The controller is operable to: perform local copy of data from the first subsidiary logical unit to the second subsidiary logical unit; bind the first virtual subsidiary logical unit to the third virtual subsidiary logical unit; set up virtual local copy of data from the third virtual subsidiary logical unit to the second virtual subsidiary logical unit; delete mapping of the first virtual subsidiary logical unit to the first subsidiary logical unit; and create mapping of the second virtual subsidiary logical unit to the second subsidiary logical unit.

In some embodiments, the controller is operable to manage a second logical unit group, which is mapped to a logical volume of an external storage system and includes a second administrative logical unit and one or more second subsidiary logical units, the logical volume of the external storage system being a unit for setting a storage function. The virtual administrative logical unit is mapped to the second administrative logical unit.

Another aspect of the invention is directed to a method of applying storage functionality in a storage system which includes a plurality of storage devices to store data and a controller operable to manage a plurality of logical volumes, each of which is a unit for setting a storage function. The method comprises: managing a logical unit group, which is mapped to one of the logical volumes and includes an administrative logical unit and one or more subsidiary logical units; and managing a virtual logical unit group which includes a plurality of virtual subsidiary logical units and a virtual administrative logical unit that is mapped to the administrative logical unit, each of which is provided to one of a plurality of virtual machines of a server, at least one virtual subsidiary logical unit being mapped to the one or more subsidiary logical units.

In some embodiments, the storage system comprises a first logical unit group that is mapped to a first logical volume of the plurality of logical volumes, and a second logical unit group that is mapped to a second logical volume of the plurality of logical volumes, the second logical volume having a different storage function from the first logical volume; wherein the plurality of virtual subsidiary logical units include a first virtual subsidiary logical unit which is initially mapped to a first subsidiary logical unit of the first logical unit group. The method further comprises: migrating data of the first subsidiary logical unit to a second subsidiary logical unit of the second logical unit group; deleting mapping of the first virtual subsidiary logical unit to the first subsidiary logical unit; and creating mapping of the first virtual subsidiary logical unit to the second subsidiary logical unit. The method further comprises: deleting the first subsidiary logical unit in the first logical unit group; determining whether there is any remaining subsidiary logical unit in the first logical unit group; and if there is no remaining subsidiary logical unit in the first logical unit group, then deleting the first logical unit group.

Another aspect of this invention is directed to a non-transitory computer-readable storage medium storing a plurality of instructions for controlling a data processor to apply storage functionality in a storage system which includes a plurality of storage devices to store data and a controller operable to manage a plurality of logical volumes, each of which is a unit for setting a storage function. The plurality of instructions comprise: instructions that cause the data processor to manage a logical unit group, which is mapped to one of the logical volumes and includes an administrative logical unit and one or more subsidiary logical units; and instructions that cause the data processor to manage a virtual logical unit group which includes a plurality of virtual subsidiary logical units and a virtual administrative logical unit that is mapped to the administrative logical unit, each of which is provided to one of a plurality of virtual machines of a server, at least one virtual subsidiary logical unit being mapped to the one or more subsidiary logical units.

These and other features and advantages of the present invention will become apparent to those of ordinary skill in the art in view of the following detailed description of the specific embodiments.

### BRIEF DESCRIPTION OF THE DRAWINGS

FIG. 1 illustrates a hardware configuration of a prior system.

FIG. 2 illustrates an example of a hardware configuration of a system in which the method and apparatus of the invention may be applied.

FIG. 3 illustrates an example of a logical configuration of the storage system.

FIG. 4 illustrates an example of a logical configuration of the host server.

FIG. 5 shows an example of a Logical Volume table.

FIG. 6 shows an example of a Physical LU Groups table.

FIG. 7 shows an example of a Virtual LU Groups table.

FIG. 8 shows a hardware configuration of a system illustrating an example of virtual LU Group mapping for configuring storage functionality involving subsidiary LU creation with storage functionality according to a first embodiment of the invention.

FIG. 9 shows an example of mapping between virtual and physical LU Groups using the Physical LU Groups table (FIG. 9a) and the Virtual LU Groups table (FIG. 9b) to illustrate configuring storage functionality according to the first embodiment.

FIG. 10 shows an example of a flow diagram illustrating a process for subsidiary LU creation with storage functionality according to the first embodiment.

FIG. 11 shows a hardware configuration of a system illustrating an example of virtual LU Group mapping for changing storage functionality according to a second embodiment of the invention.

FIG. 12 shows an example of mapping between virtual and physical LU Groups using the Physical LU Groups table (FIG. 12a) and the Virtual LU Groups table (FIG. 12b) to illustrate the state before changing storage functionality of the subsidiary volume according to the second embodiment.

FIG. 13 shows an example of mapping between virtual and physical LU Groups using the Physical LU Groups table (FIG. 13a) and the Virtual LU Groups table (FIG. 13b) to illustrate the state after changing storage functionality of the subsidiary volume according to the second embodiment.

FIG. 14 shows an example of a flow diagram illustrating a process for configuring storage functionality according to the second embodiment.

FIG. 15 shows a hardware configuration of a system illustrating an example of virtual LU Group mapping for binding subsidiary LU from source LU Group to destination LU Group with takeover storage functionality according to a third embodiment of the invention.

FIG. 16 shows an example of mapping between virtual and physical LU Groups using the Physical LU Groups table (FIG. 16a) and the Virtual LU Groups table (FIG. 16b) to illustrate the state before binding the subsidiary volume with takeover storage functionality according to the third embodiment.

FIG. 17 shows an example of mapping between virtual and physical LU Groups using the Physical LU Groups table (FIG. 17a) and the Virtual LU Groups table (FIG. 17b) to illustrate the state after binding the subsidiary volume with takeover storage functionality according to the third embodiment.

FIG. 18 shows an example of a flow diagram illustrating a process for configuring storage functionality according to the third embodiment.

FIG. 19 shows a hardware configuration of a system illustrating an example of virtual LU Group mapping for binding subsidiary LU from source LU Group to destination LU Group with takeover storage functionality according to a variation of the third embodiment of the invention as seen in FIG. 18.

FIG. 20 shows an example of a flow diagram illustrating a process for configuring storage functionality according to the variation of the third embodiment.

FIG. 21 shows a hardware configuration of a system illustrating an example of virtual LU Group mapping for binding subsidiary LU from source LU Group to destination LU Group without takeover storage functionality according to a fourth embodiment of the invention.

FIG. 22 shows an example of a flow diagram illustrating a process for configuring storage functionality according to the fourth embodiment.

FIG. 23 shows a hardware configuration of a system illustrating an example of virtual LU Group mapping for binding subsidiary LU from source LU Group to destination LU Group with takeover local copy of storage functionality according to a fifth embodiment of the invention.

FIG. 24 shows a hardware configuration of a system illustrating an example of virtual LU Group mapping for configuring storage functionality involving subsidiary LU creation with storage functionality for an external storage system according to a sixth embodiment of the invention.

FIG. 25 shows a hardware configuration of a system illustrating an example of virtual LU Group mapping for binding subsidiary LU from source LU Group to destination LU Group involving conventional LU or VMDK using SCSI extended copy process according to a seventh embodiment of the invention.

FIG. 26 shows an example of a flow diagram illustrating a process for creating QoS subsidiary LU according to the eighth embodiment.

### DETAILED DESCRIPTION OF THE INVENTION

In the following detailed description of the invention, reference is made to the accompanying drawings which form a part of the disclosure, and in which are shown by way of illustration, and not of limitation, exemplary embodiments by which the invention may be practiced. In the drawings, like numerals describe substantially similar components throughout the several views. Further, it should be noted that while the detailed description provides various exemplary embodiments, as described below and as illustrated in the drawings, the present invention is not limited to the embodiments described and illustrated herein, but can extend to other embodiments, as would be known or as would become known to those skilled in the art. Reference in the specification to “one embodiment,” “this embodiment,” or “these embodiments” means that a particular feature, structure, or characteristic described in connection with the embodiment is included in at least one embodiment of the invention, and the appearances of these phrases in various places in the specification are not necessarily all referring to the same embodiment. Additionally, in the following detailed description, numerous specific details are set forth in order to provide a thorough understanding of the present invention. However, it will be apparent to one of ordinary skill in the art that these specific details may not all be needed to practice the present invention. In other circumstances, well-known structures, materials, circuits, processes and interfaces have not been described in detail, and/or may be illustrated in block diagram form, so as to not unnecessarily obscure the present invention.

Furthermore, some portions of the detailed description that follow are presented in terms of algorithms and symbolic representations of operations within a computer. These algorithmic descriptions and symbolic representations are the means used by those skilled in the data processing arts to most effectively convey the essence of their innovations to others skilled in the art. An algorithm is a series of defined steps leading to a desired end state or result. In the present invention, the steps carried out require physical manipulations of tangible quantities for achieving a tangible result. Usually, though not necessarily, these quantities take the form of electrical or magnetic signals or instructions capable of being stored, transferred, combined, compared, and otherwise manipulated. It has proven convenient at times, principally for reasons of common usage, to refer to these signals as bits, values, elements, symbols, characters, terms, numbers, instructions, or the like. It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

The present invention also relates to an apparatus for performing the operations herein. This apparatus may be specially constructed for the required purposes, or it may include one or more general-purpose computers selectively activated or reconfigured by one or more computer programs. Such computer programs may be stored in a computer-readable storage medium including non-transient medium, such as, but not limited to optical disks, magnetic disks, read-only memories, random access memories, solid state devices and drives, or any other types of media suitable for storing electronic information. The algorithms and displays presented herein are not inherently related to any particular computer or other apparatus. Various general-purpose systems may be used with programs and modules in accordance with the teachings herein, or it may prove convenient to construct a more specialized apparatus to perform desired method steps. In addition, the present invention is not described with reference to any particular programming language. It will be appreciated that a variety of programming languages may be used to implement the teachings of the invention as described herein. The instructions of the programming language(s) may be executed by one or more processing devices, e.g., central processing units (CPUs), processors, or controllers.

Exemplary embodiments of the invention, as will be described in greater detail below, provide apparatuses, methods and computer programs for applying storage functionality to a subsidiary volume of a LU Group.

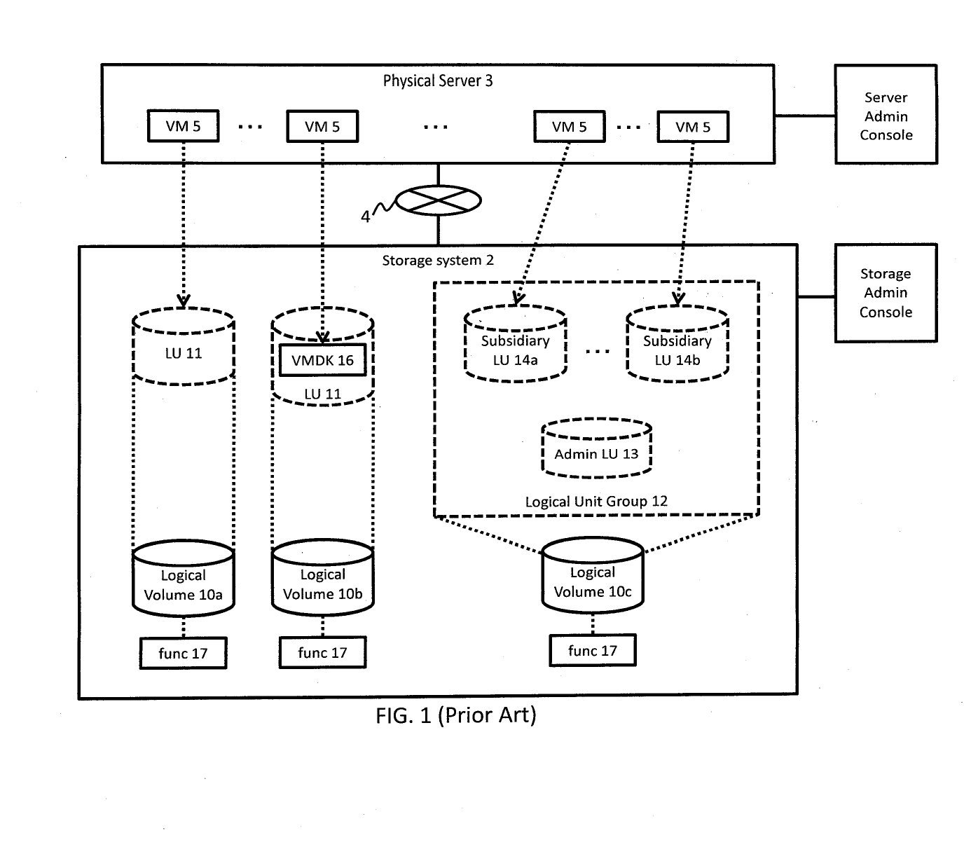

FIG. 1 illustrates a hardware configuration of a prior system.

The system includes a storage system 2, a physical server 3, and a network 4. The physical server 3 has a plurality of virtual machines (VMs). The storage system 2 has a plurality of Logical Volumes 10 each of which contains a conventional Logical Unit (LU) 11 or a Logical Unit (LU) Group 12. The Logical Unit Group 12 includes an Administrative LU 13 and zero or one or more Subsidiary LUs 14. The LU 11 may contain a virtual machine disk (VMDK) file 16. The Administrative LU 13 controls the LU Group 12 to configure, create, delete, or migrate a plurality of subsidiary LUs 14. Each Subsidiary LU 14 contains a disk image of VM 5 respectively.

Recently, the conventional LU 11 is created by a Logical Volume 10. The LU Group 12 is created to include a plurality of Subsidiary LUs 14, although the Logical Volume 10c corresponding to the LU Group 12 is one volume. The conventional LU applies a plurality of storage functionalities, if configured. Each subsidiary LU 14 of the LU Group 12 inherits the storage functionalities which are applied to the logical volume 10c. The storage administrator could not configure different storage functionalities 17 for each subsidiary LU 14 of the same LU Group 12.

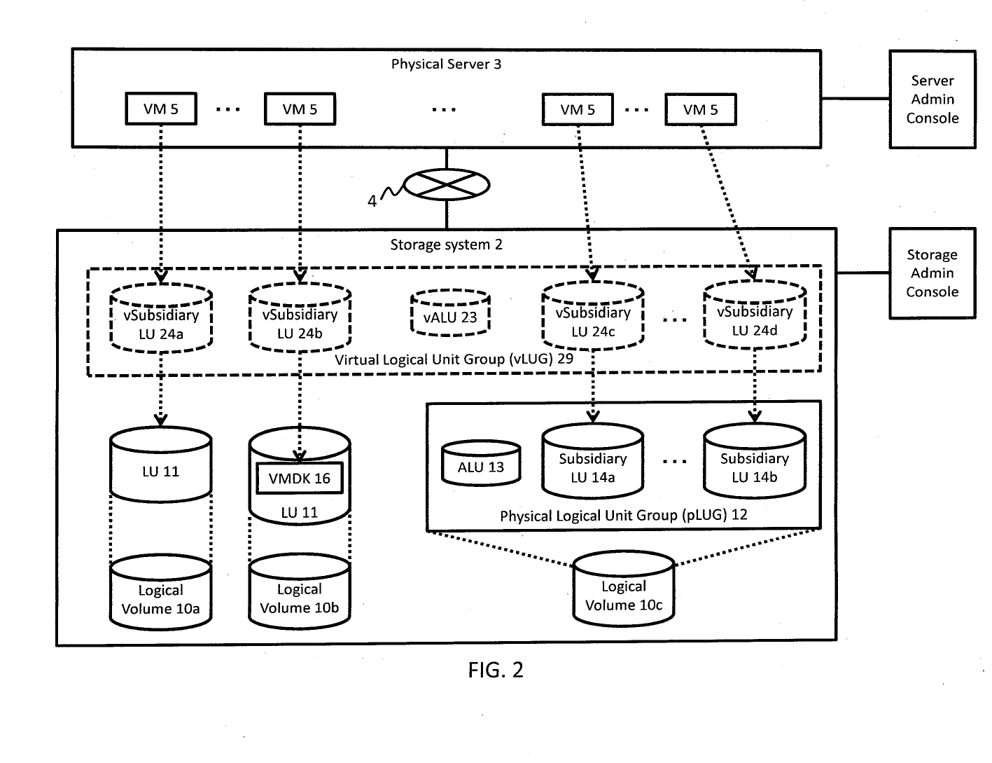

FIG. 2 illustrates an example of a hardware configuration of a system in which the method and apparatus of the invention may be applied. The storage system 2 has a virtual logical unit group (vLUG) 29 which is a mapping layer from the conventional LU 11 or the physical subsidiary LU 14 of the physical LU Group (pLUG) to the virtual subsidiary LU 24. The vLUG 29 has a virtual administrative logical unit (vALU) 23 and a plurality of virtual subsidiary LUs 24. The vALU 23 manages the conventional LU 11, the VMDK 16, or the administrative LU (ALU) 13 of the pLUG 12. The virtual subsidiary LU (vSLU) 24 is mapped to the conventional LU 11, the VMDK 16, or the subsidiary LU (SLU) 14a of the pLUG 12.

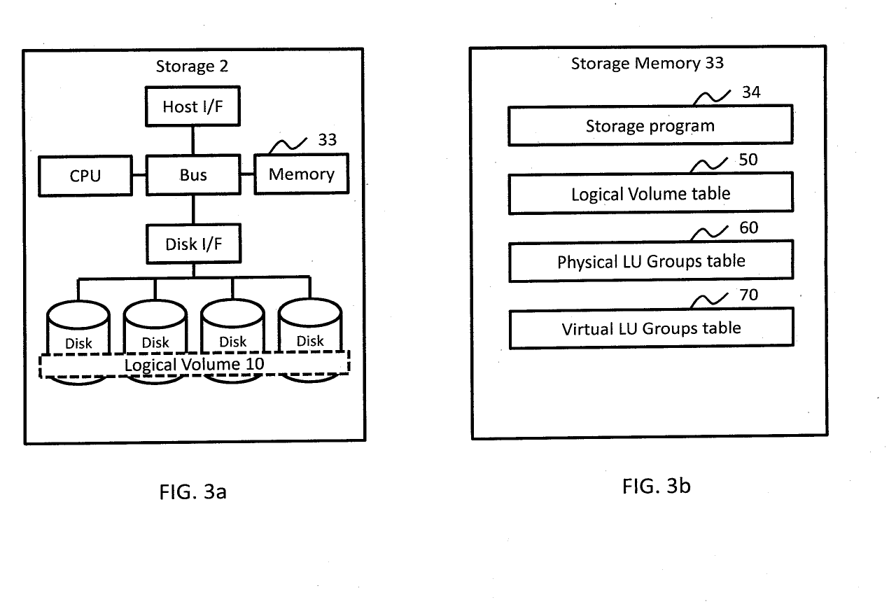

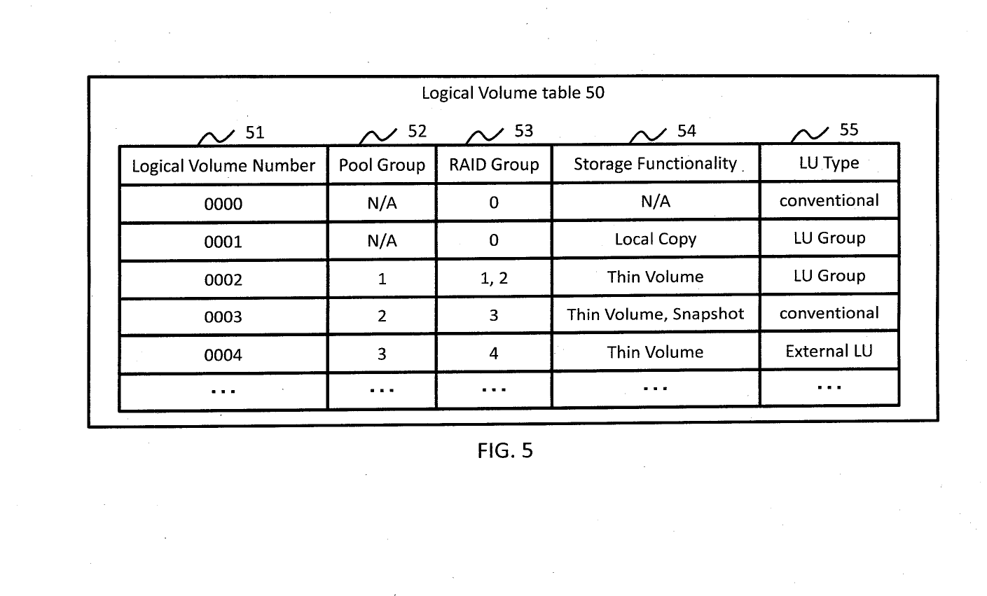

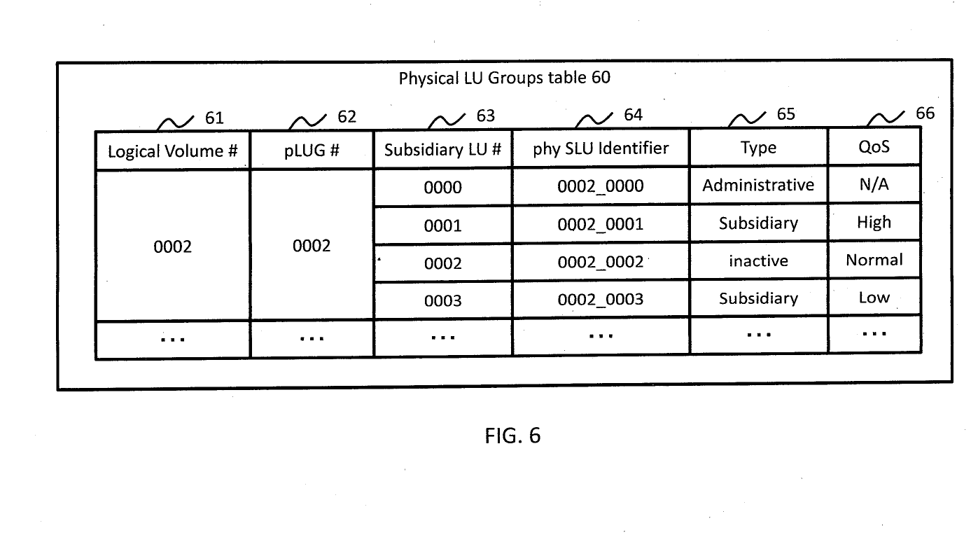

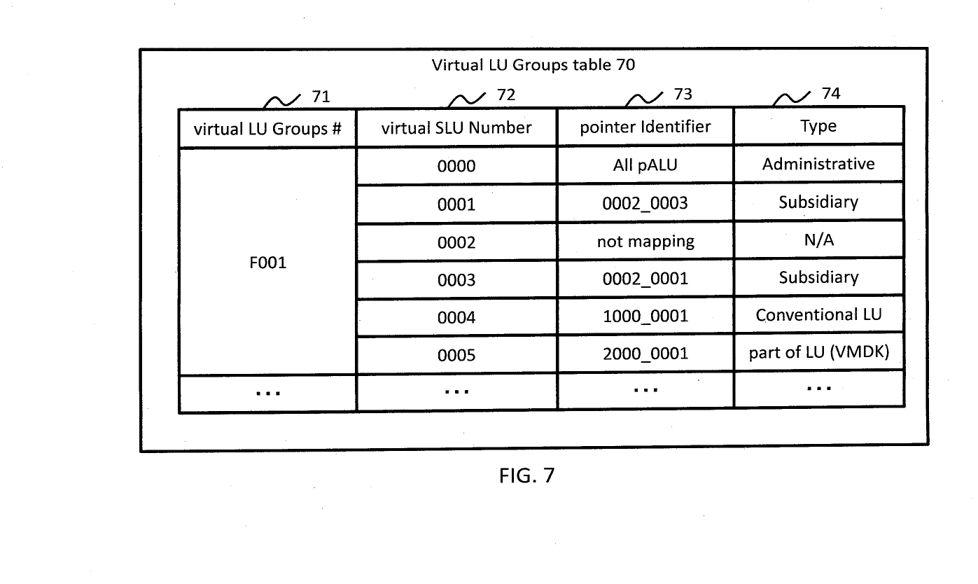

FIG. 3 illustrates an example of a logical configuration of the storage system 2. As seen in FIG. 3a, the physical storage system 2 includes a host I/F (interface) which connects to host, CPU, Memory, Disk I/F, and HDDs, and these components are connected to each other by a Bus I/F such as PCI, DDR, SCSI. As seen in FIG. 3b, a storage memory 33 contains storage program 34, Logical Volume table 50 (FIG. 5), Physical LU Groups table 60 (FIG. 6), and Virtual LU Groups table 70 (FIG. 7).

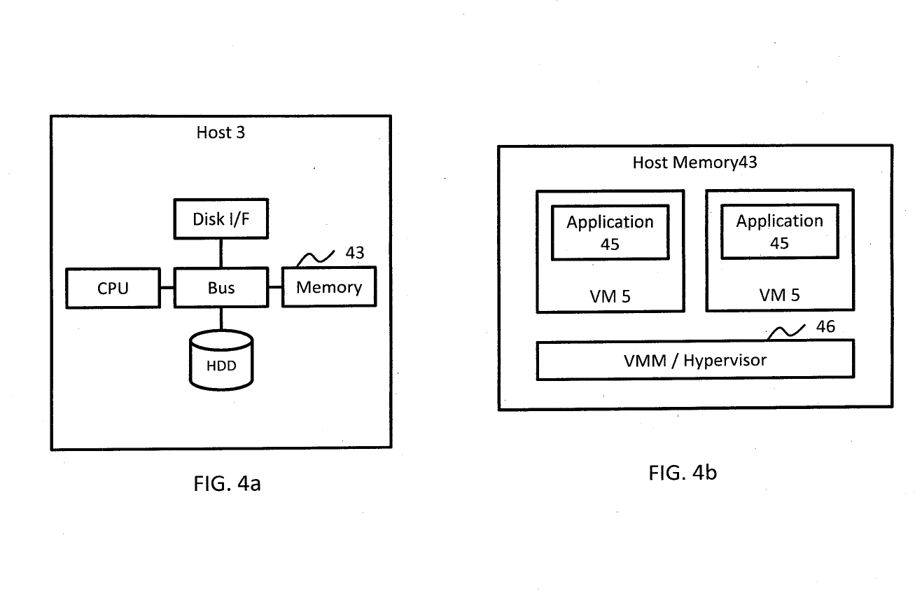

FIG. 4 illustrates an example of a logical configuration of the host server 3. As seen in FIG. 4a, the physical host 3 includes CPU, Memory, Disk I/F which connects to the storage system 2, and HDDs, and these components are connected to each other by a Bus I/F such as PCI, DDR, and SCSI. As seen in FIG. 4b, a host memory 43 contains virtual machine 5, application software 45, and virtual machine manager (VMM) or hypervisor 46.

FIG. 5 shows an example of a Logical Volume table 50. The Logical Volume table 50 includes Logical Volume number field 51, Pool Group field 52, RAID Group field 53, Storage Functionality field 54, and LU type field 55. Logical Volume number field 51 shows identification number of Logical Volume 11. Pool Group field 52 shows data pool for applying thin provisioning volume. RAID Group field 53 shows RAID Groups containing a plurality of disks. Storage functionality field 54 shows function(s) being applied to Logical Volume 10. LU type field 55 shows classification for conventional LU 11 or LU Group 12 or external LU.

FIG. 6 shows an example of a Physical LU Groups table 60. This table 60 includes Logical Volume number field 61, physical LU Group (pLUG) number field 62, subsidiary LU number field 63, physical subsidiary LU (SLU) identifier field 64, type field 65, and QoS (Quality of Service) field 66. A LU Group entry contains one administrative LU and a plurality of Subsidiary LUs. Subsidiary LU number field 63 is a unique ID in the pLUG number 62. Physical SLU ID 64 is concatenate of field 62 and field 63. Type field 65 shows classification for administrative LU, subsidiary LU, or inactive LU. QoS field 66 may be high, normal, or low for subsidiary or inactive type, or N/A for administrative type.

FIG. 7 shows an example of a Virtual LU Groups table 70. This table 70 includes virtual LU Group number field 71, virtual subsidiary LU number field 72, pointer identifier 73, and type field 74. The entry for the pointer identifier 73 may be the physical subsidiary LU ID or “All pALU” (All physical administrative LU) or “not mapping”. Type field 74 shows classification for administrative LU or subsidiary LU or conventional LU or part of LU (VMDK) or “N/A” which corresponds to a pointer identifier 73 of “not mapping”. The Virtual LU Groups table 70 provides mapping of virtual LU group and physical LU group.

### First Embodiment

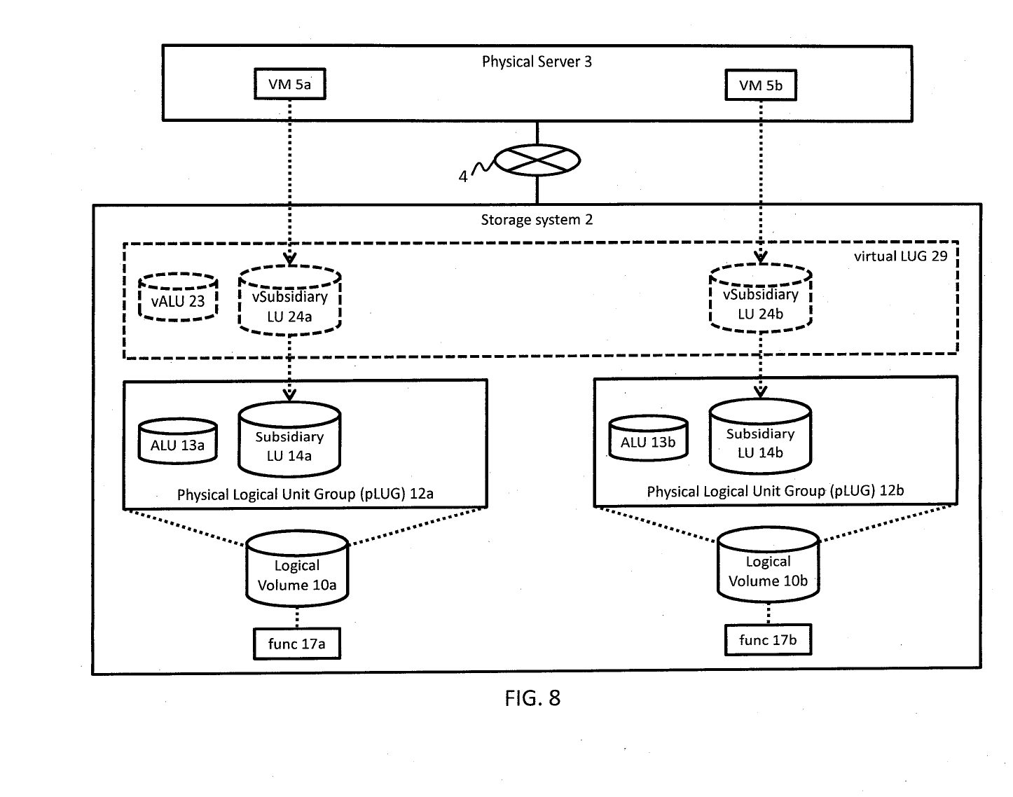

FIG. 8 shows a hardware configuration of a system illustrating an example of virtual LU Group mapping for configuring storage functionality involving subsidiary LU creation with storage functionality according to a first embodiment of the invention. The following is an overview of configuring storage functionality. When the server administrator creates one LU Group and two subsidiary LUs for different storage functionalities, the hypervisor of server 3 issues two SCSI management commands to the virtual administrative LU of the storage system 23 to create two different configuration subsidiary LUs. Then the storage program reroutes the first received command to the physical LUG (pLUG) 12a and creates the SLU 14a with configuring the first storage functionality 17a and returns the SCSI status to the server 3. The hypervisor of the serve 3 issues a SCSI management command to the virtual administrative LU 23 of storage system 2. Then, the storage program reroutes the second received command to the physical LUG (pLUG) 12b and creates the SLU 14b with configuring second storage functionality 17b and returns SCSI status to the server 3.

For hypervisor view, the hypervisor accesses virtual LU group 29, then one administrative LU 23 and two subsidiary LU 24a, 24b, although there are two Logical Volumes 10a and 10b with different storage functionality configurations. Thus, the storage administrator does not create two LU groups of different storage functionality configurations manually. The hypervisor could manage one administrative LU of one LU Group.

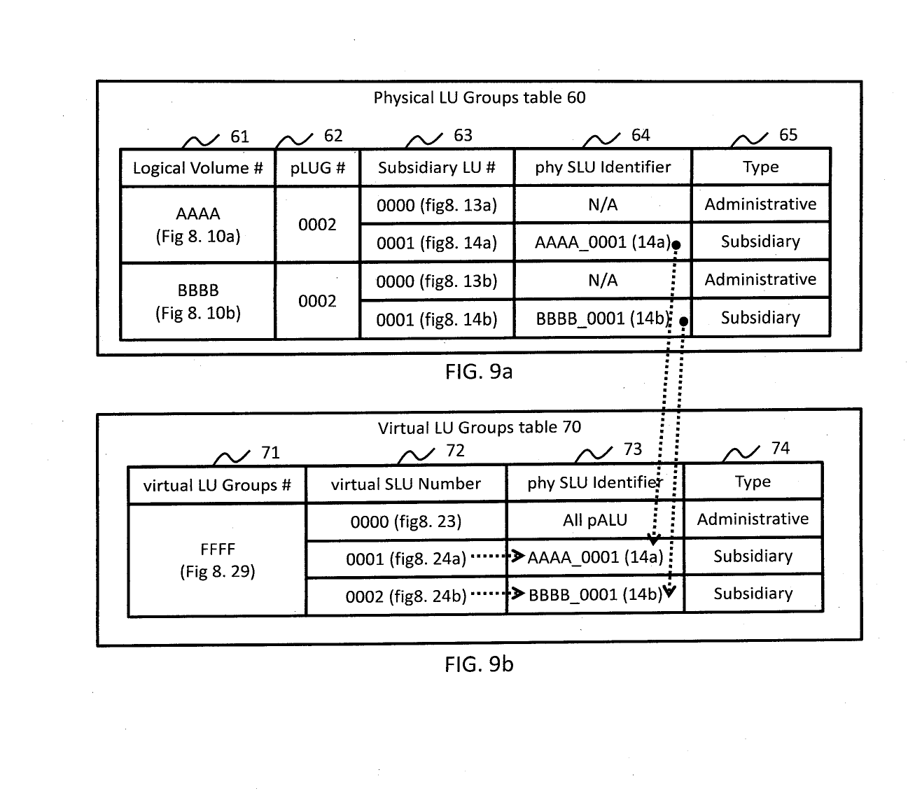

FIG. 9 shows an example of mapping between virtual and physical LU Groups using the Physical LU Groups table 60 (FIG. 9a) and the Virtual LU Groups table 70 (FIG. 9b) to illustrate configuring storage functionality according to the first embodiment. The Virtual LU Group (LUG) FFFF (vLUG 29 in FIG. 8) has one virtual administrative LU (vALU) 23 and two virtual subsidiary LUs (vSLUs) 24a and 24b. Each vSLU (24a, 24b) is mapped to a corresponding physical SLU (14a, 14b). More specifically, vSLU number 0001 (24a in FIG. 8) is mapped to physical SLU identifier AAAA_{—}0001 (14a in FIG. 8) and vSLU number 0002 (24b in FIG. 8) is mapped to physical SLU identifier BBBB_{—}0001 (14b in FIG. 8), as seen in fields 72 and 73 in FIG. 9b.

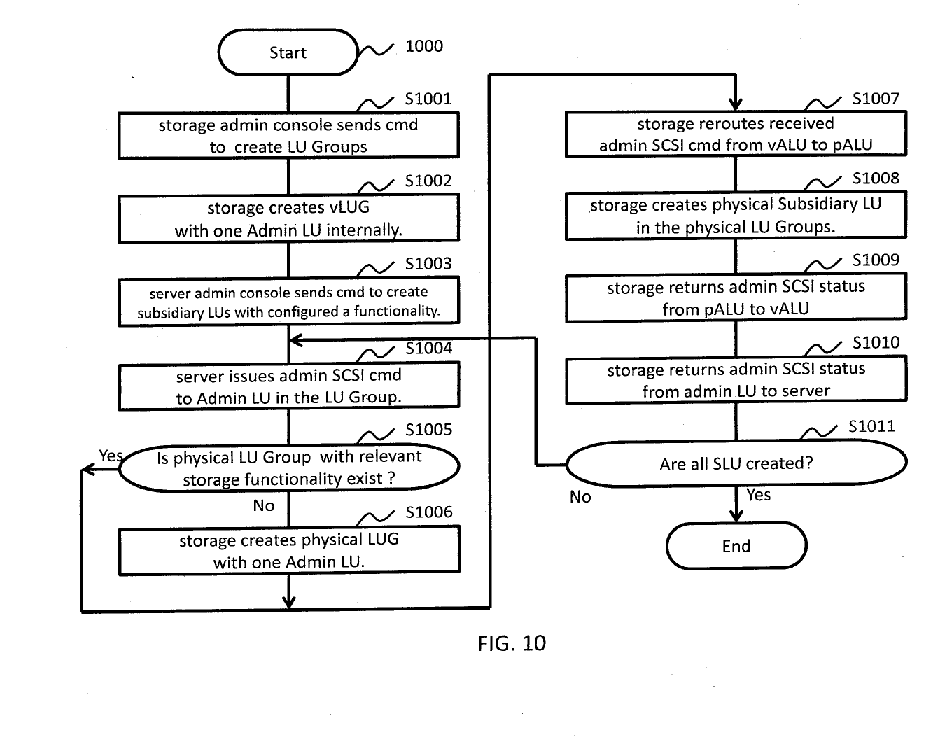

FIG. 10 shows an example of a flow diagram 1000 illustrating a process for subsidiary LU creation with storage functionality according to the first embodiment. In step S1001, the storage administrator via console sends a command to create LU Group, if the storage system does not have any LU Group which could be accessed by the hypervisor. In step S1002, the storage system 2 creates vLUG with one Admin LU internally. In step S1003, the server administrator via console sends a command to create virtual subsidiary LUs with configured functionality (see virtual LUG table of FIG. 7). In step S1004, the server hypervisor issues an admin SCSI command to the Admin LU in the LU Group to create subsidiary LUs with list parameter which contains one or more LU creation parameter. In step S1005, the storage program determines whether a physical LU Group with the relevant storage functionality already exists or not. If No, the next step is S1006. If Yes, the next step is S1007. In step S1006, the storage program creates a physical LU Group with one Admin LU which is internally mapped behind the virtual LU Group (see mapping in FIG. 9 of LUs in FIG. 8). In step S1007, the storage program reroutes the received admin SCSI command from the virtual Admin LU to the internal physical Admin LU. In step S1008, the storage program creates physical Subsidiary LU in the physical LU Groups (see physical LUG table of FIG. 6). The storage program expands capacity or allocate from pool volume if the capacity of the LU Group is insufficient (see Logical Volume table of FIG. 5). In step S1009, the storage program returns admin SCSI status from physical Admin LU to virtual Admin LU when the received admin SCSI command operations are finished. In step S1010, the storage program returns admin SCSI status from admin LU to server when the storage system receives a status check command and the admin SCSI command operations are finished. In step S1011, The process from S1004 to S1010 continues until all SLUs are created.

### Second Embodiment

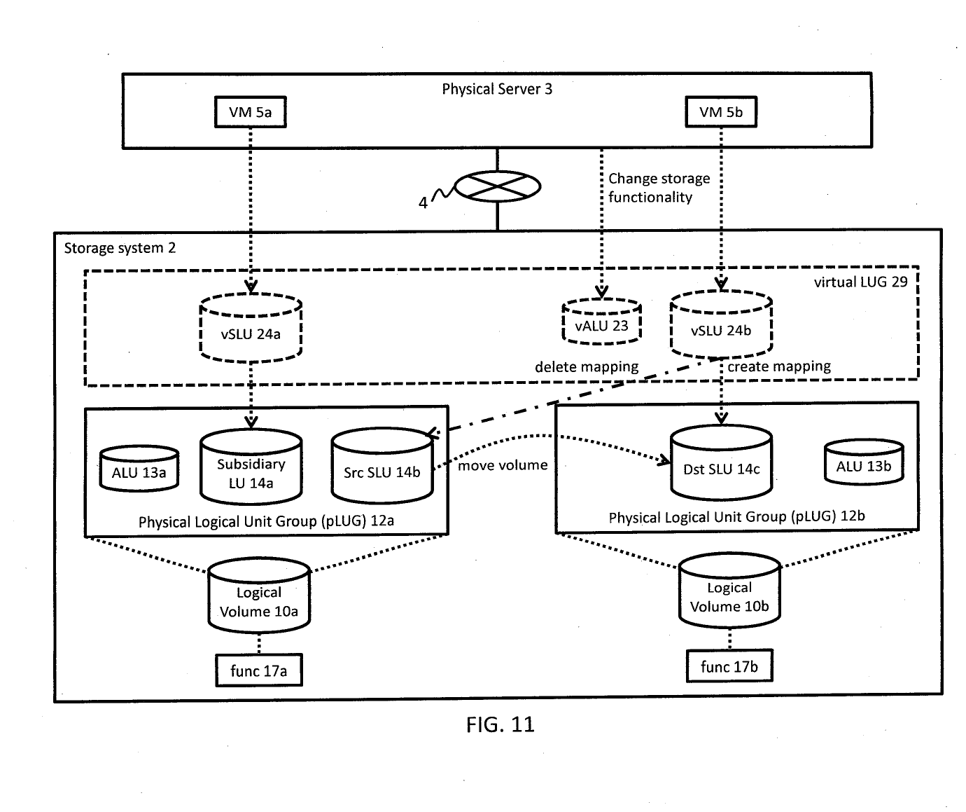

FIG. 11 shows a hardware configuration of a system illustrating an example of virtual LU Group mapping for changing storage functionality according to a second embodiment of the invention. The following is an overview of changing storage functionality. When the server administrator changes storage functionality, the hypervisor issues an admin SCSI command to the virtual Administrative LU 23. Then, the storage program creates physical LUG (pLUG) 12b, if no pLUG has storage functionality that is relevant to the changed storage functionality 17b. If some pLUG has storage functionality that is relevant to the changed storage functionality 17b, however, the storage program reroutes the received admin SCSI command to the physical LUG (pLUG) 12b and creates SLU 14c with configuring first storage functionality 17b. The storage program migrates subsidiary LU data from the source SLU 14b to the destination SLU 14c. During migration, the storage program reroutes the received read/write command from the server to the source SLU, with referred mapping of vSLU 24b to source SLU 14b. When the storage program completes the migration of data, the storage program changes the mapping to a mapping of vSLU 24b to destination SLU 14c (instead of source SLU 14b). For hypervisor view, the hypervisor could change storage functionality configuration for each subsidiary LU of a LU Group respectively and non-disruptively.

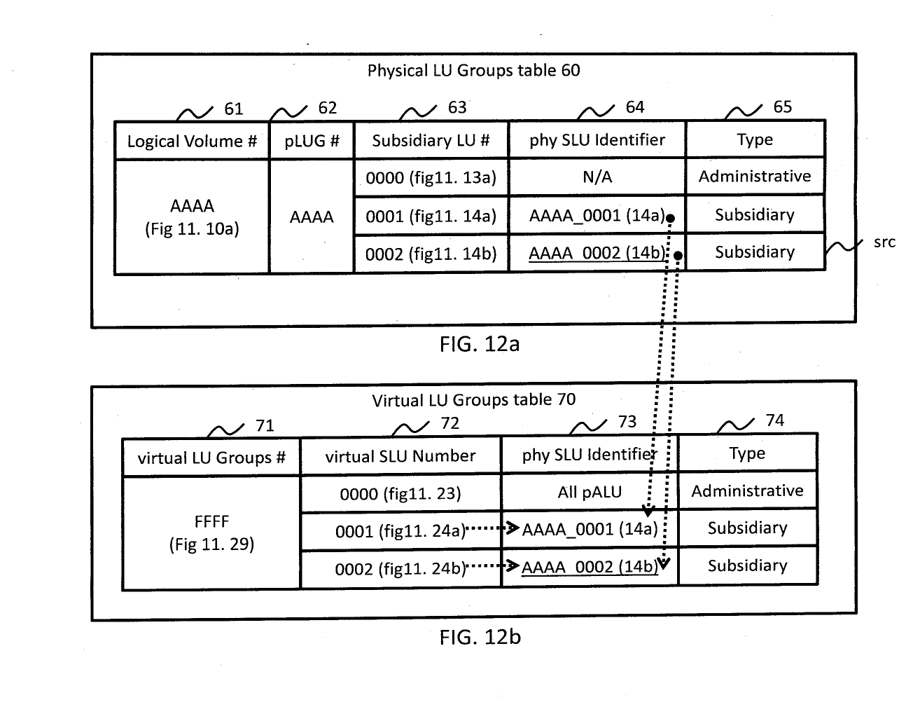

FIG. 12 shows an example of mapping between virtual and physical LU Groups using the Physical LU Groups table 60 (FIG. 12a) and the Virtual LU Groups table 70 (FIG. 12b) to illustrate the state before changing storage functionality of the subsidiary volume according to the second embodiment. Subsidiary LU AAAA_{—}0002 (14b) belongs to the physical LU Group 12a and is to be moved to the physical LU Group 12b to become subsidiary LU BBBB_{—}0001 (14c); both are mapped to virtual LU Group FFFF. Logical volume AAAA (10a) has storage functionality 17a.

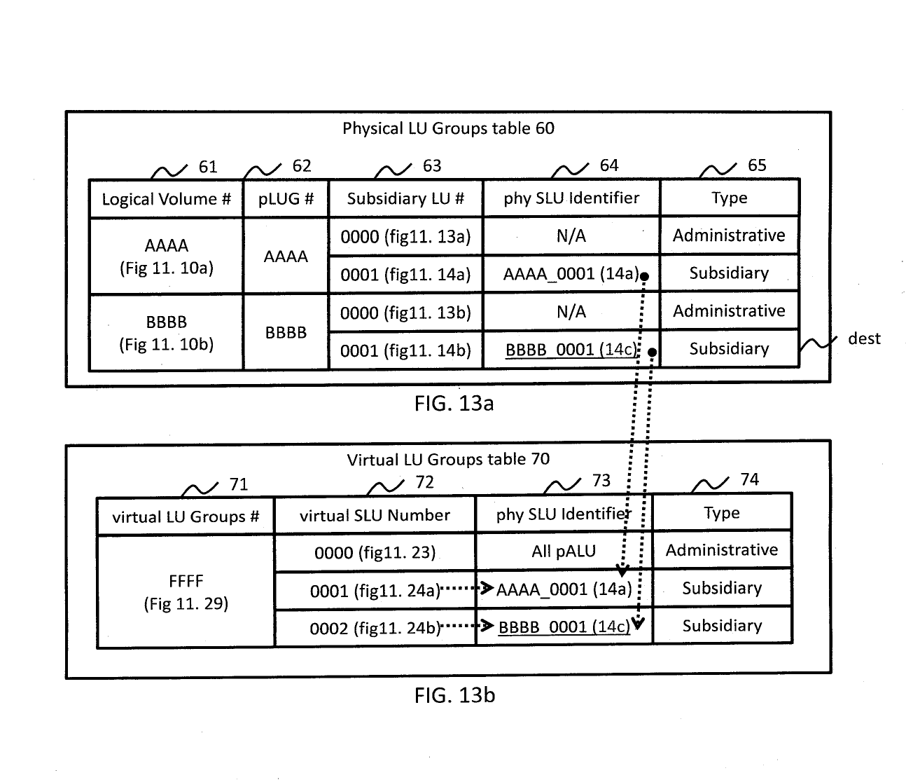

FIG. 13 shows an example of mapping between virtual and physical LU Groups using the Physical LU Groups table 60 (FIG. 13a) and the Virtual LU Groups table 70 (FIG. 13b) to illustrate the state after changing storage functionality of the subsidiary volume according to the second embodiment. Source Logical Volume AAAA (10a) has storage functionality 17a and Destination Logical Volume BBBB (10b) has storage functionality 17b. The Subsidiary LU inherits the storage functionality based on the Logical Volume (i.e., changing from source to destination).

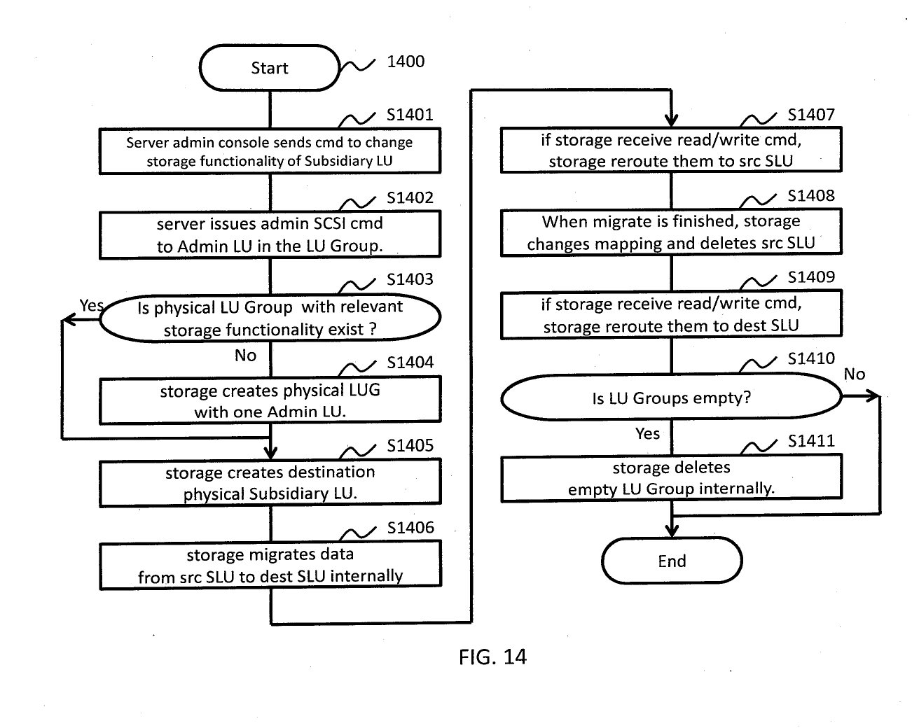

FIG. 14 shows an example of a flow diagram 1400 illustrating a process for configuring storage functionality according to the second embodiment. In step S1401, the server administrator via console sends a command to change the storage functionality of a virtual subsidiary LU. In step S1402, the server hypervisor issues an admin SCSI command to the Administrative LU 23 in the virtual LU Group 29 to change the storage functionality of the subsidiary LU. In step S1403, the storage program determines whether the physical LU Group has storage functionality that is relevant to the changed storage functionality. If No, the next step is S1404. If Yes, the next step is S1405. In step S1404, the storage program creates the physical LU Group with one Administrative LU which is internally mapped behind the virtual LU Group (see mapping in FIG. 12 of LUs in FIG. 11). In step S1405, the storage program creates the destination physical subsidiary LU. In step S1406, the storage program performs to migrate LU data from source Subsidiary LU to destination Subsidiary LU internally (see migration in FIG. 11).

In step S1407, if the storage system receives read/write command during migration, the storage program reroutes the received read/write command from virtual Subsidiary LU to source Subsidiary LU, with referred mapping of virtual Subsidiary LU 24b to source Subsidiary LU 14b (see FIG. 12b). In step S1408, when the storage program finishes the migration of data, the storage program changes the mapping to a mapping of virtual Subsidiary LU 24b to destination Subsidiary LU 14c and deletes the source Subsidiary LU 14b (see FIG. 11 for changes to mapping). In step S1409, after the migration of data is finished internally, the storage program reroutes the received read/write command from virtual Subsidiary LU to destination Subsidiary LU, with referred mapping of virtual Subsidiary LU 24b to destination Subsidiary LU 14c (see FIG. 13b). In step S1410, the storage program determines whether the LU Group 12a, which contained the source subsidiary LU 14b that was deleted in step S1408, has any subsidiary LU left or is now empty. If Yes to empty, the next step is S1411. If No to empty, the process ends. In step S1411, the storage program deletes the empty LU Group 12a internally, because the LU group does not have any subsidiary LU (administrative LU is management LU of LU Group). The process of FIG. 14 enables the server hypervisor to change storage functionality with subsidiary LU granularity, after the subsidiary LU is created.

### Third Embodiment

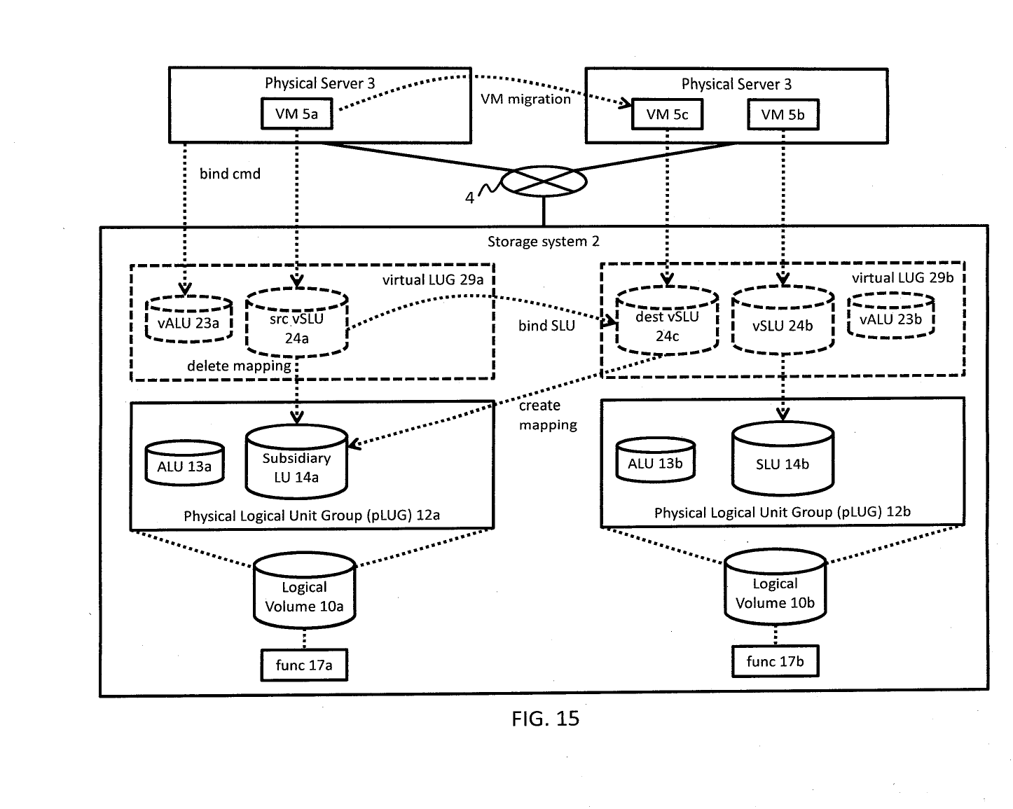

FIG. 15 shows a hardware configuration of a system illustrating an example of virtual LU Group mapping for binding subsidiary LU from source LU Group to destination LU Group with takeover storage functionality according to a third embodiment of the invention. When the server administrator changes binding of a subsidiary LU to another LU Group, the hypervisor issues an admin SCSI command to the virtual Administrative LU 23a. The storage program changes mapping between virtual SLU and physical subsidiary LU (from 24a-14a pair to 24c-14a pair). The storage program does not perform to move data of physical subsidiary LU 14a. For hypervisor view, the hypervisor could change binding subsidiary LU from the LU group to another LU group non-disruptively, with takeover storage functionality.

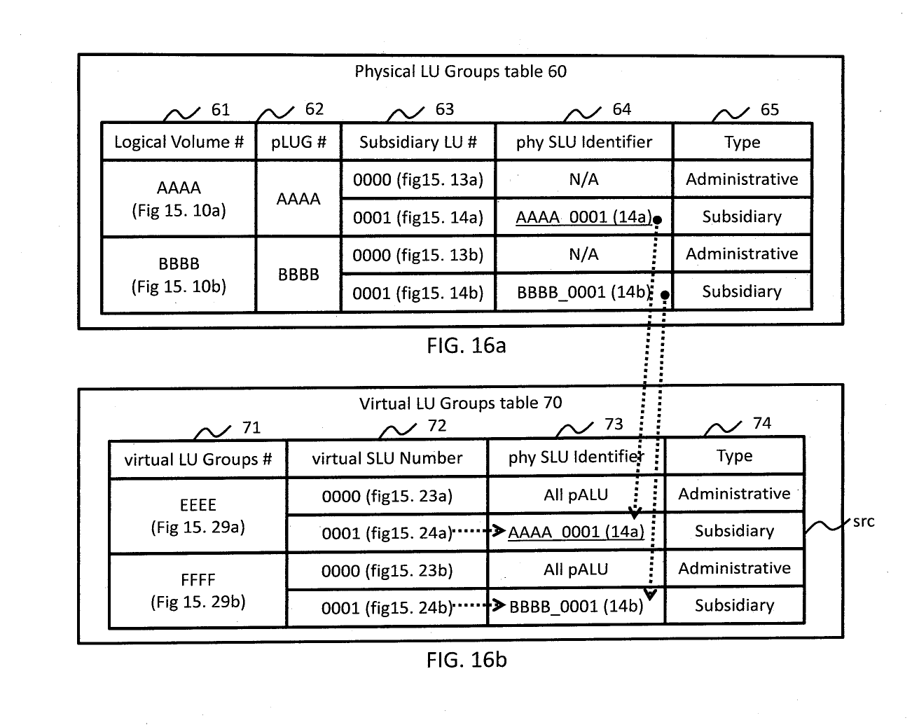

FIG. 16 shows an example of mapping between virtual and physical LU Groups using the Physical LU Groups table 60 (FIG. 16a) and the Virtual LU Groups table 70 (FIG. 16b) to illustrate the state before binding the subsidiary volume with takeover storage functionality according to the third embodiment. Subsidiary LU AAAA_{—}0001 (14a) belongs to the physical LU Group 12a and is initially mapped to source vSLU 24a in virtual LU Group EEEE (29a); the mapping is then changed to destination vSLU 24c in virtual LU Group FFFF (29b). Logical volume AAAA (10a) has storage functionality 17a.

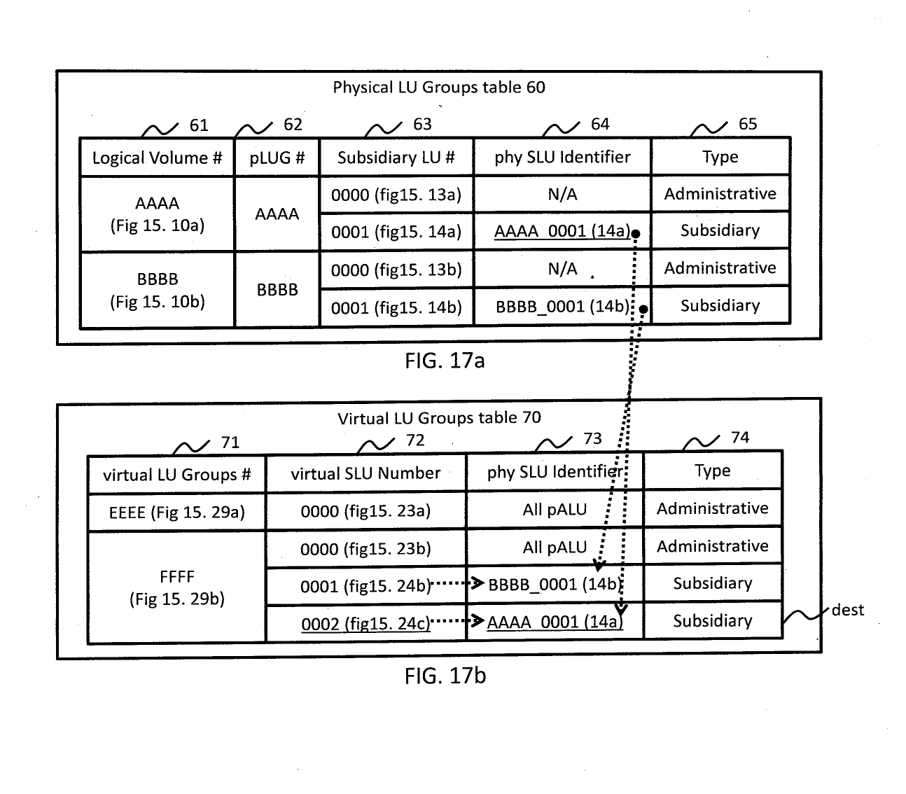

FIG. 17 shows an example of mapping between virtual and physical LU Groups using the Physical LU Groups table 60 (FIG. 17a) and the Virtual LU Groups table 70 (FIG. 17b) to illustrate the state after binding the subsidiary volume with takeover storage functionality according to the third embodiment. Subsidiary LU AAAA_{—}0001 (14a) has binding with LU Group FFFF (29b). Binding Subsidiary LU AAAA_{—}0001 (14a) has takeover storage functionality 17a.

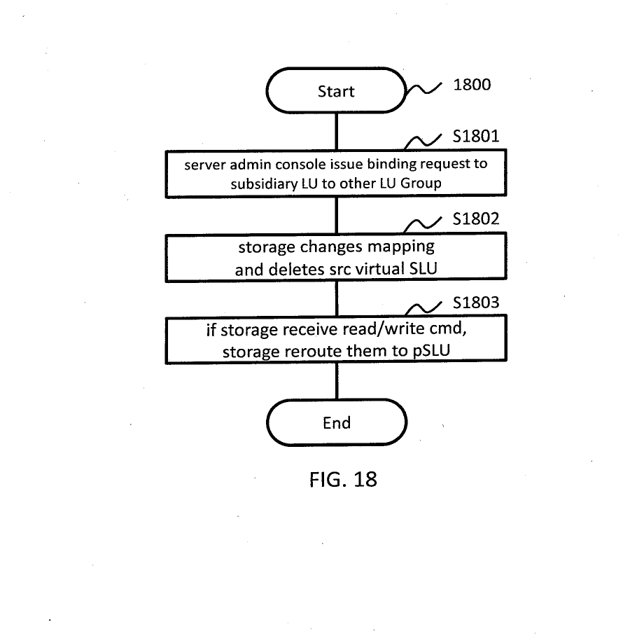

FIG. 18 shows an example of a flow diagram 1800 illustrating a process for configuring storage functionality according to the third embodiment. In step S1801, the server administrator via console issues a binding request to bind a subsidiary LU to another virtual LU Group. In step S1802, the storage program changes the mapping between the physical subsidiary LU 14a and the source vSLU 24a to a mapping between the physical subsidiary LU 14a and the destination vSLU 24c (see change of mapping in FIG. 15), and deletes the source vSLU 24a. In step S1803, if the storage system receives a read/write command, the storage program reroutes the command from the vSLU 24c to the physical SLU 14a (see FIG. 17b). As seen in FIG. 15, the binding of virtual subsidiary LU from source LU Group to destination LU Group with takeover storage functionality reflects VM migration from VM 5a of physical server 3 to VM 5c of another physical server 3.

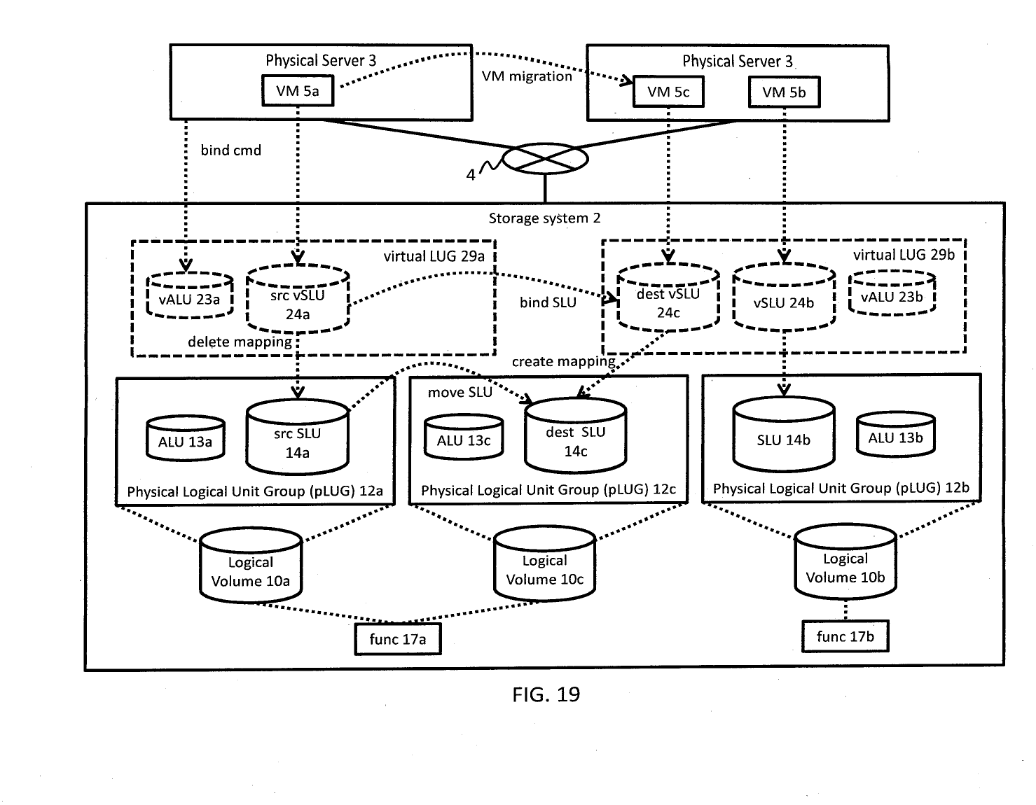

FIG. 19 shows a hardware configuration of a system illustrating an example of virtual LU Group mapping for binding subsidiary LU from source LU Group to destination LU Group with takeover storage functionality according to a variation of the third embodiment of the invention as seen in FIG. 15. When the server administrator changes binding of a subsidiary LU to another LU Group, the hypervisor issues an admin SCSI command to the Administrative LU 23a. The storage program changes the mapping between virtual SLU and physical subsidiary LU (from 24a-14a pair to 24c-14c pair). The difference from FIG. 15 is that the storage program in FIG. 19 performs to move data of the physical subsidiary LU 14a to the physical subsidiary LU 14c. For hypervisor view, the hypervisor could change binding subsidiary LU from the LU group to another LU group non-disruptively, with takeover storage functionality.

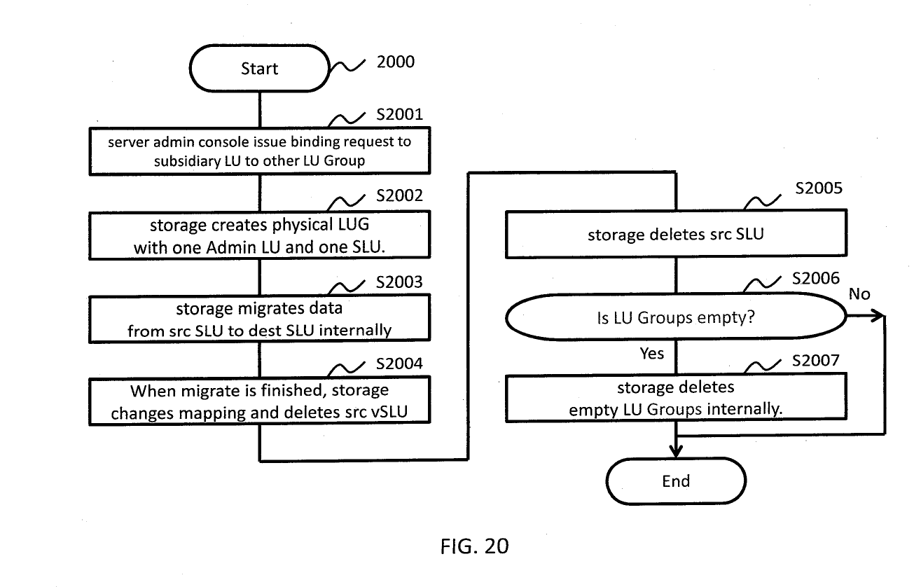

FIG. 20 shows an example of a flow diagram 2000 illustrating a process for configuring storage functionality according to the variation of the third embodiment. This flow diagram corresponds to the mapping of FIG. 19, and is a variation of the flow diagram of FIG. 18 corresponding to the mapping of FIG. 15. In step S2001, the server administrator via console issues a binding request to bind a subsidiary LU to another virtual LU Group. More specifically, the binding request is to bind a source vSLU 24a of virtual LUG 29a, which is mapped to a source SLU 14a of physical LUG 12a, to another virtual LUG 29b. In step S2002, the storage program creates a physical LUG 12c with one Administrative LU 13c and one Subsidiary LU 14c (see FIG. 19). The physical LUG 12c belongs to Logical Volume 10c with the same storage functionality 17a as Logical Volume 10a to which the physical LUG 12a belongs. In step S2003, the storage program performs to migrate LU data from the source SLU 14a to the destination SLU 14c internally (see FIG. 19). In step S2004, when migration is finished, the storage program changes the mapping between the source vSLU 24a and source SLU 14a to a mapping between the destination SLU 24c to destination SLU 14c (see change of mapping in FIG. 19), and deletes the source vSLU 24a. In step S2005, the storage program deletes the source SLU 14a. In step S2006, the storage program determines whether the physical LU Group 12a is empty or not and whether the virtual LU Group 29a is empty or not (i.e., whether there is any subsidiary LU left). If Yes, the storage program deletes the empty LU Group(s) internally in step S2007, because the LU group does not have any subsidiary LU (administrative LU is management LU of LU Group). If No, the process ends.

The processes of FIG. 18 and FIG. 20 enable that serve hypervisor to bind subsidiary LU granularity with takeover storage functionality.

### Fourth Embodiment

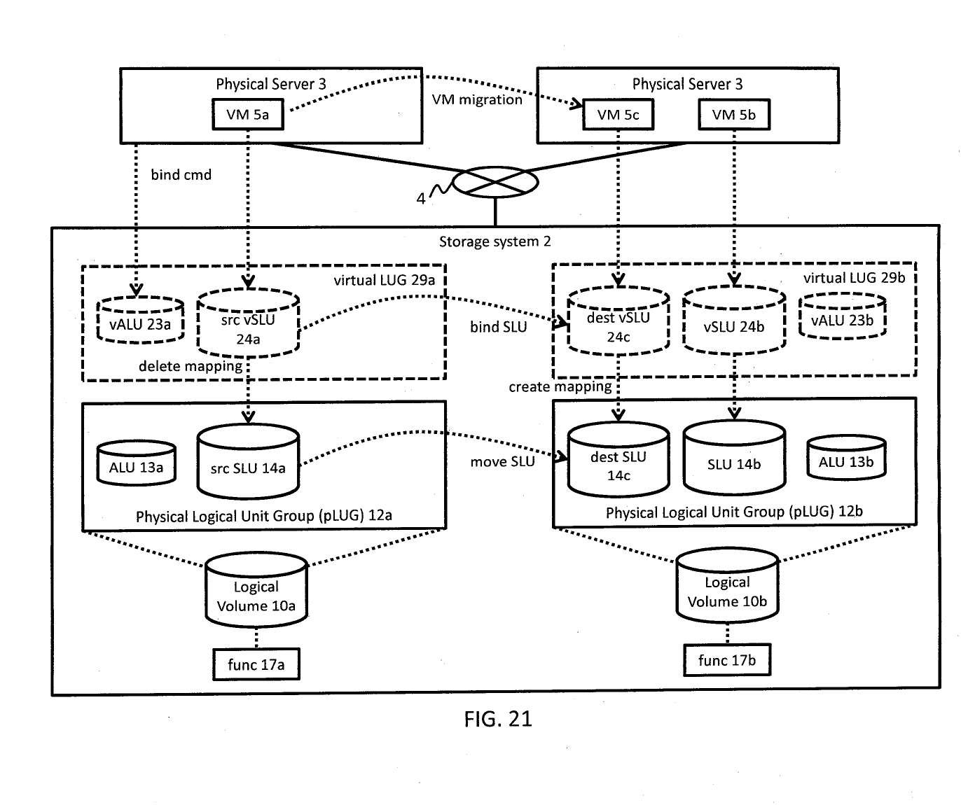

FIG. 21 shows a hardware configuration of a system illustrating an example of virtual LU Group mapping for binding subsidiary LU from source LU Group to destination LU Group without takeover storage functionality according to a fourth embodiment of the invention. As compared to FIG. 19, FIG. 21 shows no creation of the physical LUG 12c. Instead, there is migration of LU data from the source SLU 14a of physical LUG 12a to a destination SLU 14c of physical LUG 12b and there is a new mapping from the destination vSLU 24c to the destination SLU 14c, with a change of the storage functionality 17a associated with logical volume 10a to the storage functionality 17b associated with logical volume 10b.

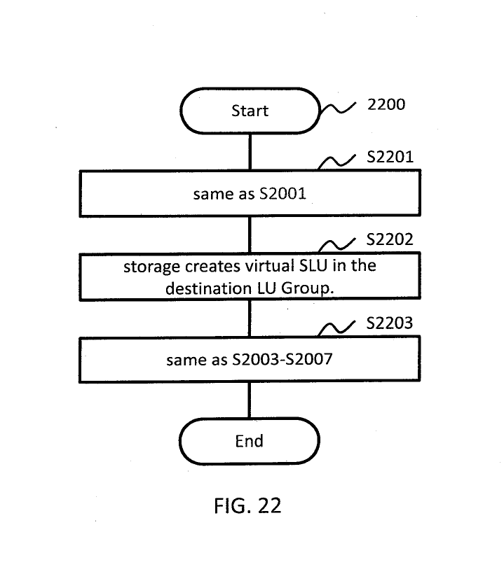

FIG. 22 shows an example of a flow diagram 2200 illustrating a process for configuring storage functionality according to the fourth embodiment. Step S2201 is the same as step S2001 of FIG. 20. In step S2202, the storage program creates virtual SLU 24c in the destination virtual LUG 29b and physical SLU 14c in the destination physical LUG 12b, which belongs to Logical Volume 10b with storage functionality 17b. Step S2203 is the same as steps S2003-S2007 of FIG. 20. The process of FIG. 22 enables the serve hypervisor to change storage functionality with subsidiary LU granularity, after subsidiary LU is created.

### Fifth Embodiment

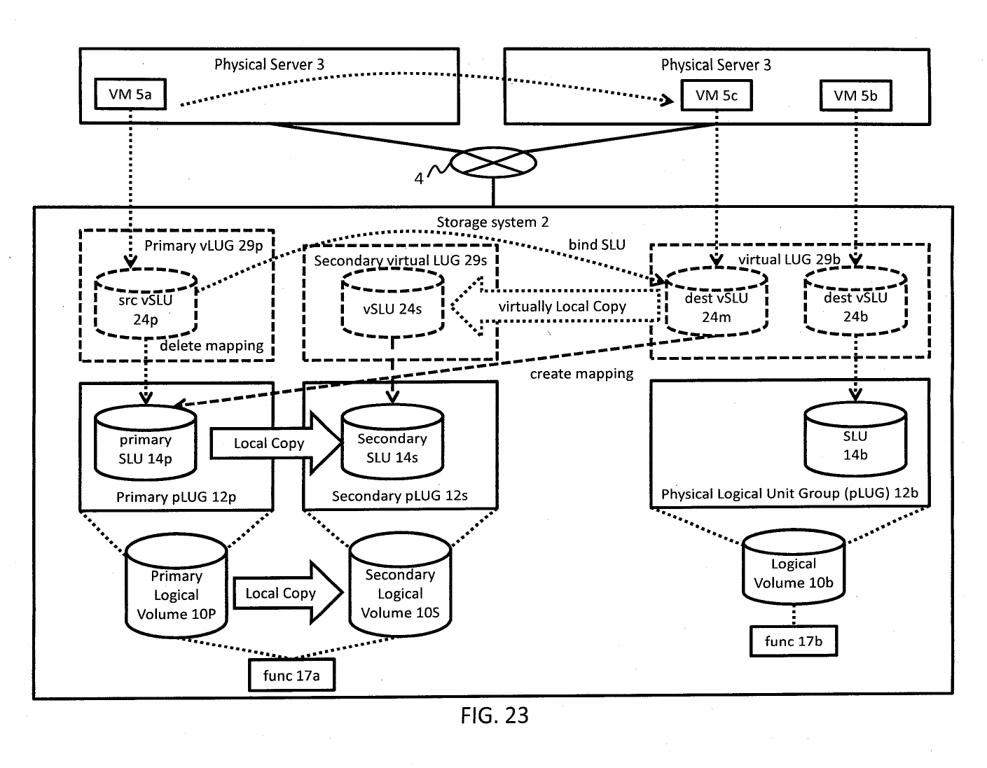

FIG. 23 shows a hardware configuration of a system illustrating an example of virtual LU Group mapping for binding subsidiary LU from source LU Group to destination LU Group with takeover local copy of storage functionality according to a fifth embodiment of the invention. The storage program performs local copy functionality between Primary Logical Volume 10p and Secondary Logical Volume 10s. Both Primary Logical Volume 10p and Secondary Logical Volume 10b create physical LU Groups 12p and 12s. When binding is performed to bind the source subsidiary LU 24p to another virtual LU Group 29b, the storage program creates a destination virtual LU 24m in the virtual LUG 29b, and the storage program changes the mapping between the source vSLU 24p and the primary SLU 14p to a mapping between the destination vSLU 24m and the primary SLU 14p. Then, the storage program deletes the source virtual subsidiary LU 24p, and the storage program finishes the binding process.

For hypervisor view, after the hypervisor issues a binding request with takeover local copy of storage functionality of a subsidiary LU, the storage system continues to process local copy virtually between the destination virtual subsidiary LU 24m (primary LU) and the secondary virtual subsidiary LU 24s (secondary LU), because physical mapping is not changed between the primary subsidiary LU 14p and the secondary subsidiary LU 14s.

### Sixth Embodiment

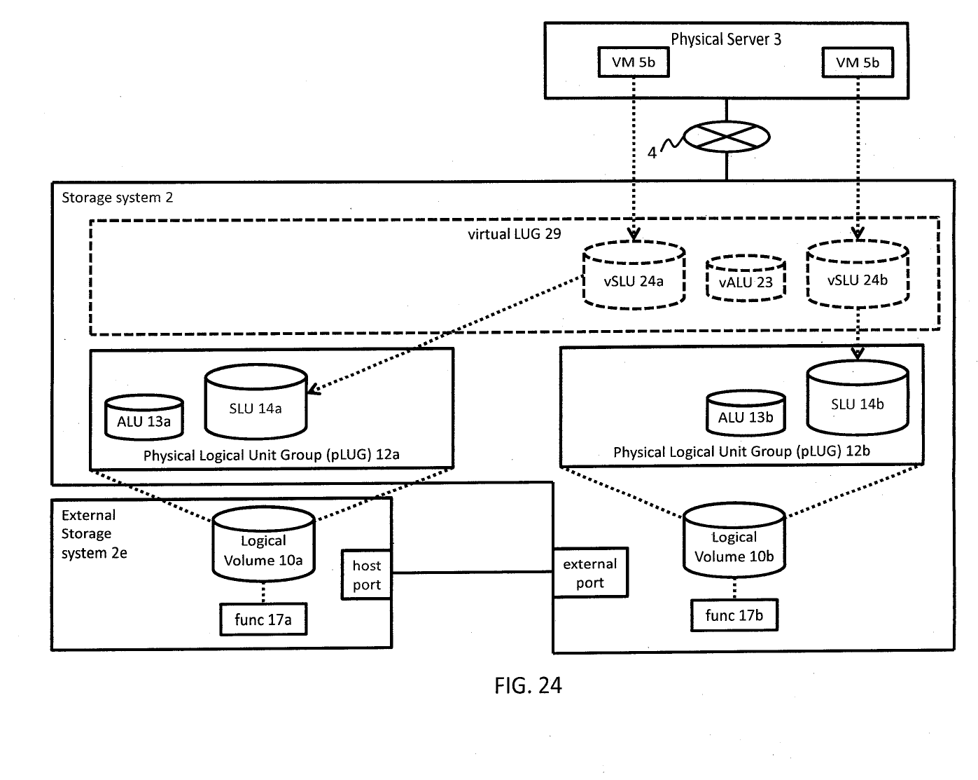

FIG. 24 shows a hardware configuration of a system illustrating an example of virtual LU Group mapping for configuring storage functionality involving subsidiary LU creation with storage functionality for an external storage system according to a sixth embodiment of the invention. As compared to the first embodiment of FIG. 8, the difference is that the physical LUG 12a belongs to Logical Volume 10a (with storage functionality 17a) of an external storage system 2a.

### Seventh Embodiment

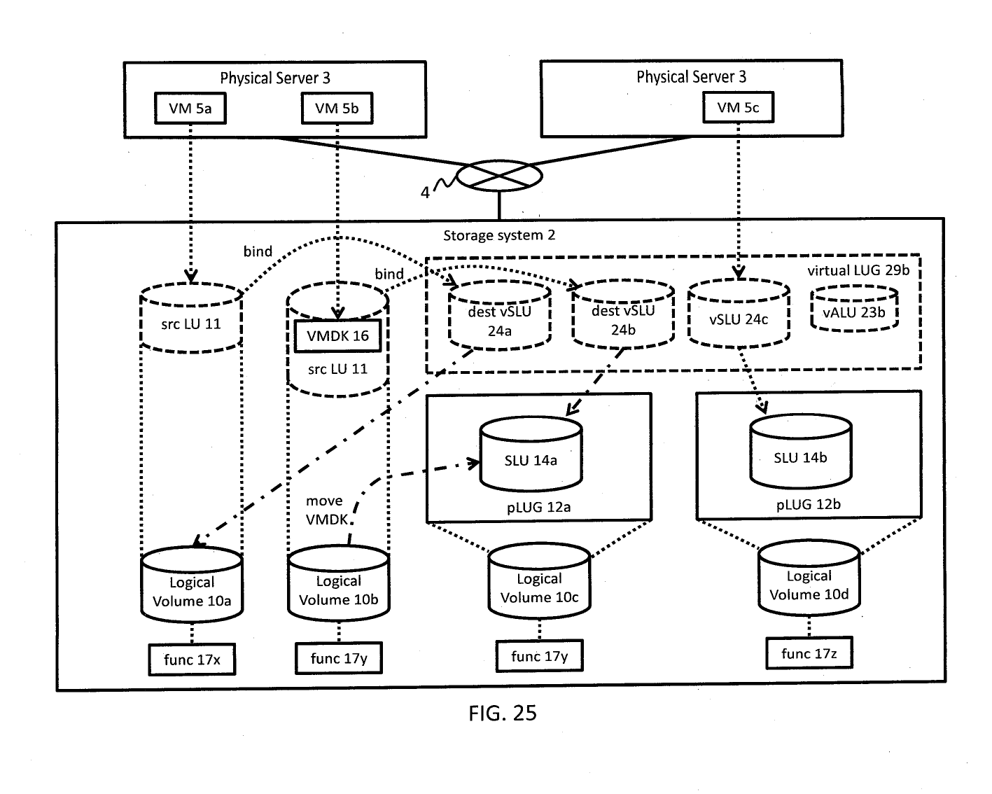

FIG. 25 shows a hardware configuration of a system illustrating an example of virtual LU Group mapping for binding subsidiary LU from source LU Group to destination LU Group involving conventional LU or VMDK using SCSI extended copy process according to a seventh embodiment of the invention. FIG. 25 shows that the binding process could be applied to conventional LU or VMDK using SCSI extended copy process.

For the conventional LU (source LU 11 which belongs to Logical Volume 10a having storage functionality 17x), as compared to the third embodiment of FIG. 15, the binding of source LU 11 to the virtual LUG 29b and the mapping of the destination vSLU 24a of the virtual LUG 29b to Logical Volume 10a (in FIG. 25) is analogous to the binding of source vSLU 24a which is mapped to SLU 14a to the virtual LUG 29b and the mapping of the destination vSLU 24c to the SLU 14a of the physical LUG 12a (in FIG. 15).

For the VMDK 16 (of source LU 11 which belongs to Logical volume 10b having storage functionality 17y), as compared to the third embodiment variation of FIG. 19, the binding of VMDK 16 of source LU 11 to the virtual LUG 29b and the data migration of the VMDK to a physical SLU 14a of a physical LUG 12a which belongs to Logical Volume 10c having the same functionality 17y as Logical Volume 10a and the mapping of the destination vSLU 24b of the virtual LUG 29b to the physical SLU 14a (in FIG. 25) is analogous to the binding of the source vSLU 24a which is mapped to the source SLU 14a to the virtual LUG 29b and the data migration of the source SLU 14a to the destination SLU 14c of the physical LUG 12c which belongs to Logical Volume 10c having the same storage functionality 17a as Logical Volume 10a and the mapping of the destination vSLU 24c of the virtual LUG 29b to the destination SLU 14c (in FIG. 19).

### Eighth Embodiment

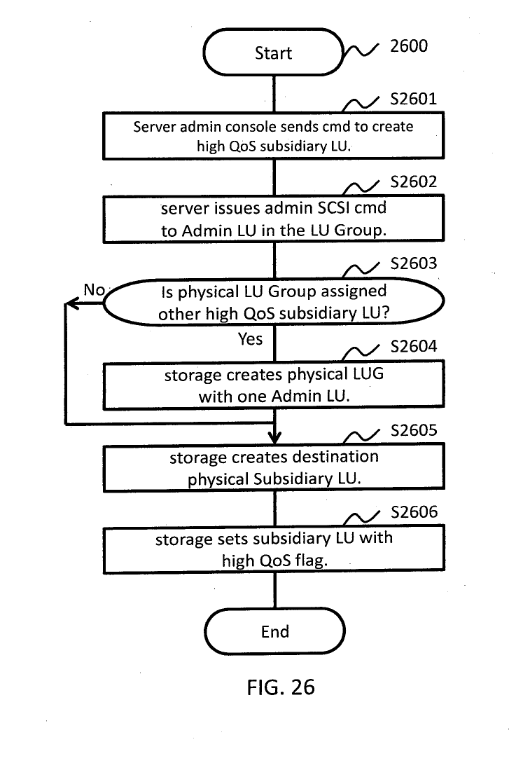

FIG. 26 shows an example of a flow diagram 2600 illustrating a process for creating QoS subsidiary LU according to the eighth embodiment. In step S2601, the server administrator via console sends a command to create a high QoS subsidiary LU. In step S2602, the server issues an administrative SCSI command to the administrative LU in the LU Group. In step S2603, the storage program determines whether a physical LU Group is assigned some other high QoS subsidiary LU or not. If Yes, the storage program creates a physical LUG with one administrative LU in step S2604. If No, the process skips step S2604. Then, in step S2605, the storage program creates a destination physical subsidiary LU. In step S2606, the storage program sets the subsidiary LU with a high QoS flag. The process ends.

Of course, the system configurations illustrated in FIGS. 2, 8, 11, 15, 19, 21, and 23-25 are purely exemplary of information systems in which the present invention may be implemented, and the invention is not limited to a particular hardware configuration. The computers and storage systems implementing the invention can also have known I/O devices (e.g., CD and DVD drives, floppy disk drives, hard drives, etc.) which can store and read the modules, programs and data structures used to implement the above-described invention. These modules, programs and data structures can be encoded on such computer-readable media. For example, the data structures of the invention can be stored on computer-readable media independently of one or more computer-readable media on which reside the programs used in the invention. The components of the system can be interconnected by any form or medium of digital data communication, e.g., a communication network. Examples of communication networks include local area networks, wide area networks, e.g., the Internet, wireless networks, storage area networks, and the like.

In the description, numerous details are set forth for purposes of explanation in order to provide a thorough understanding of the present invention. However, it will be apparent to one skilled in the art that not all of these specific details are required in order to practice the present invention. It is also noted that the invention may be described as a process, which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged.

As is known in the art, the operations described above can be performed by hardware, software, or some combination of software and hardware. Various aspects of embodiments of the invention may be implemented using circuits and logic devices (hardware), while other aspects may be implemented using instructions stored on a machine-readable medium (software), which if executed by a processor, would cause the processor to perform a method to carry out embodiments of the invention. Furthermore, some embodiments of the invention may be performed solely in hardware, whereas other embodiments may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

From the foregoing, it will be apparent that the invention provides methods, apparatuses and programs stored on computer readable media for applying storage functionality to a subsidiary volume of a logical unit group. Additionally, while specific embodiments have been illustrated and described in this specification, those of ordinary skill in the art appreciate that any arrangement that is calculated to achieve the same purpose may be substituted for the specific embodiments disclosed. This disclosure is intended to cover any and all adaptations or variations of the present invention, and it is to be understood that the terms used in the following claims should not be construed to limit the invention to the specific embodiments disclosed in the specification. Rather, the scope of the invention is to be determined entirely by the following claims, which are to be construed in accordance with the established doctrines of claim interpretation, along with the full range of equivalents to which such claims are entitled.

What is claimed is:

1. A storage system comprising:
a plurality of storage devices to store data; and
a controller operable to manage a plurality of logical volumes, each of which is a unit for setting a storage function;
wherein the controller is operable to manage a logical unit group, which is mapped to one of the logical volumes and includes an administrative logical unit and one or more subsidiary logical units; and
wherein the controller is operable to manage a virtual logical unit group which includes a plurality of virtual subsidiary logical units and a virtual administrative logical unit that is mapped to the administrative logical unit, each of which is provided to one of a plurality of virtual machines of a server, at least one virtual subsidiary logical unit being mapped to the one or more subsidiary logical units.

2. The storage system according to claim 1,
wherein the plurality of virtual subsidiary logical units include a first virtual subsidiary logical unit and a second virtual subsidiary logical unit;
wherein the first virtual subsidiary logical unit is mapped to a first subsidiary logical unit of a first logical unit group that is mapped to a first logical volume of the plurality of logical volumes; and
wherein the second virtual subsidiary logical unit is mapped to either a second subsidiary logical unit of a second logical unit group that is mapped to a second logical volume of the plurality of logical volumes or to another one of the plurality of logical volumes.

3. The storage system according to claim 1, comprising a first logical unit group that is mapped to a first logical volume of the plurality of logical volumes, and a second logical unit group that is mapped to a second logical volume of the plurality of logical volumes, the second logical volume having a different storage function from the first logical volume;
wherein the plurality of virtual subsidiary logical units include a first virtual subsidiary logical unit which is initially mapped to a first subsidiary logical unit of the first logical unit group; and
wherein the controller is operable to migrate data of the first subsidiary logical unit to a second subsidiary logical unit of the second logical unit group, delete mapping of the first virtual subsidiary logical unit to the first subsidiary logical unit, and create mapping of the first virtual subsidiary logical unit to the second subsidiary logical unit.

4. The storage system according to claim 3,
wherein the controller is operable to delete the first subsidiary logical unit in the first logical unit group, determine whether there is any remaining subsidiary logical unit in the first logical unit group, and, if there is no remaining subsidiary logical unit in the first logical unit group, then delete the first logical unit group.

5. The storage system according to claim 1, comprising a first virtual logical unit group having a first virtual administrative logical unit that is mapped to a first administrative logical unit of a first logical unit group that is mapped to a first logical volume of the plurality of logical volumes, and a second virtual logical unit group having a second virtual administrative logical unit that is mapped to a second administrative logical unit of a second logical unit group that is mapped to a second logical volume of the plurality of logical volumes, the second logical volume having a different storage function from the first logical volume;
wherein the first virtual subsidiary logical unit has a first virtual subsidiary logical unit which is initially mapped to a first subsidiary logical unit of the first logical unit group; and
wherein the controller is operable to bind the first virtual subsidiary logical unit of the first virtual logical unit group to a second virtual subsidiary logical unit of the second virtual logical unit group, delete mapping of the first virtual subsidiary logical unit to the first subsidiary logical unit, and create mapping of the second virtual subsidiary logical unit to the first subsidiary logical unit.

6. The storage system according to claim 1, comprising a first virtual logical unit group having a first virtual administrative logical unit that is mapped to a first administrative logical unit of a first logical unit group that is mapped to a first logical volume of the plurality of logical volumes, and a second virtual logical unit group having a second virtual administrative logical unit that is mapped to a second administrative logical unit of a second logical unit group that is mapped to a second logical volume of the plurality of logical volumes, the second logical volume having a different storage function from the first logical volume;
wherein the first virtual subsidiary logical unit has a first virtual subsidiary logical unit which is initially mapped to a first subsidiary logical unit of the first logical unit group; and
wherein the controller is operable to:
bind the first virtual subsidiary logical unit of the first virtual logical unit group to a second virtual subsidiary logical unit of the second virtual logical unit group;
migrate data of the first subsidiary logical unit to a third subsidiary logical unit of a third logical unit group which is mapped to a third logical volume of the plurality of logical volumes, the third logical volume having a same storage function as the first logical volume;
delete mapping of the first virtual subsidiary logical unit to the first subsidiary logical unit; and
create mapping of the second virtual subsidiary logical unit to the third subsidiary logical unit.

7. The storage system according to claim 1, comprising a first virtual logical unit group having a first virtual administrative logical unit that is mapped to a first administrative logical unit of a first logical unit group that is mapped to a first logical volume of the plurality of logical volumes, and a second virtual logical unit group having a second virtual administrative logical unit that is mapped to a second administrative logical unit of a second logical unit group that is mapped to a second logical volume of the plurality of logical volumes, the second logical volume having a different storage function from the first logical volume;
wherein the first virtual subsidiary logical unit has a first virtual subsidiary logical unit which is initially mapped to a first subsidiary logical unit of the first logical unit group; and
wherein the controller is operable to:
bind the first virtual subsidiary logical unit of the first virtual logical unit group to a second virtual subsidiary logical unit of the second virtual logical unit group;
migrate data of the first subsidiary logical unit to a second subsidiary logical unit of the second logical unit group;
delete mapping of the first virtual subsidiary logical unit to the first subsidiary logical unit; and
create mapping of the second virtual subsidiary logical unit to the second subsidiary logical unit.

8. The storage system according to claim 1, comprising a first virtual logical unit group having a first virtual administrative logical unit that is mapped to a first administrative logical unit of a first logical unit group that is mapped to a first logical volume of the plurality of logical volumes; a second virtual logical unit group having a second virtual administrative logical unit that is mapped to a second administrative logical unit of a second logical unit group that is mapped to a second logical volume of the plurality of logical volumes, the second logical volume having a same storage function as the first logical volume; and a third virtual logical unit group having a third virtual administrative logical unit that is mapped to a third administrative logical unit of a third logical unit group that is mapped to a third logical volume of the plurality of logical volumes, the third logical volume having a different storage function from the first logical volume;
wherein the first virtual subsidiary logical unit has a first virtual subsidiary logical unit which is initially mapped to a first subsidiary logical unit of the first logical unit group; and
wherein the controller is operable to:
perform local copy of data from the first subsidiary logical unit to the second subsidiary logical unit;
bind the first virtual subsidiary logical unit to the third virtual subsidiary logical unit;
set up virtual local copy of data from the third virtual subsidiary logical unit to the second virtual subsidiary logical unit;
delete mapping of the first virtual subsidiary logical unit to the first subsidiary logical unit; and
create mapping of the second virtual subsidiary logical unit to the second subsidiary logical unit.

9. The storage system according to claim 1,
wherein the controller is operable to manage a second logical unit group, which is mapped to a logical volume of an external storage system and includes a second administrative logical unit and one or more second subsidiary logical units, the logical volume of the external storage system being a unit for setting a storage function; and
wherein the virtual administrative logical unit is mapped to the second administrative logical unit.

10. A method of applying storage functionality in a storage system which includes a plurality of storage devices to store data and a controller operable to manage a plurality of logical volumes, each of which is a unit for setting a storage function; the method comprising:
managing a logical unit group, which is mapped to one of the logical volumes and includes an administrative logical unit and one or more subsidiary logical units; and
managing a virtual logical unit group which includes a plurality of virtual subsidiary logical units and a virtual administrative logical unit that is mapped to the administrative logical unit, each of which is provided to one of a plurality of virtual machines of a server, at least one virtual subsidiary logical unit being mapped to the one or more subsidiary logical units.

11. The method according to claim 10, wherein the plurality of virtual subsidiary logical units include a first virtual subsidiary logical unit and a second virtual subsidiary logical unit; the method further comprising:
mapping the first virtual subsidiary logical unit to a first subsidiary logical unit of a first logical unit group that is mapped to a first logical volume of the plurality of logical volumes; and
mapping the second virtual subsidiary logical unit to either a second subsidiary logical unit of a second logical unit group that is mapped to a second logical volume of the plurality of logical volumes or to another one of the plurality of logical volumes.

12. The method according to claim 10, wherein the storage system comprises a first logical unit group that is mapped to a first logical volume of the plurality of logical volumes, and a second logical unit group that is mapped to a second logical volume of the plurality of logical volumes, the second logical volume having a different storage function from the first logical volume; wherein the plurality of virtual subsidiary logical units include a first virtual subsidiary logical unit which is initially mapped to a first subsidiary logical unit of the first logical unit group; the method further comprising:
migrating data of the first subsidiary logical unit to a second subsidiary logical unit of the second logical unit group;
deleting mapping of the first virtual subsidiary logical unit to the first subsidiary logical unit; and
creating mapping of the first virtual subsidiary logical unit to the second subsidiary logical unit.

13. The method according to claim 12, further comprising:
deleting the first subsidiary logical unit in the first logical unit group;
determining whether there is any remaining subsidiary logical unit in the first logical unit group; and
if there is no remaining subsidiary logical unit in the first logical unit group, then deleting the first logical unit group.

14. The method according to claim 10, wherein the storage system comprises a first virtual logical unit group having a first virtual administrative logical unit that is mapped to a first administrative logical unit of a first logical unit group that is mapped to a first logical volume of the plurality of logical volumes, and a second virtual logical unit group having a second virtual administrative logical unit that is mapped to a second administrative logical unit of a second logical unit group that is mapped to a second logical volume of the plurality of logical volumes, the second logical volume having a different storage function from the first logical volume; wherein the first virtual subsidiary logical unit has a first virtual subsidiary logical unit which is initially mapped to a first subsidiary logical unit of the first logical unit group; the method further comprising:
binding the first virtual subsidiary logical unit of the first virtual logical unit group to a second virtual subsidiary logical unit of the second virtual logical unit group;
deleting mapping of the first virtual subsidiary logical unit to the first subsidiary logical unit; and
creating mapping of the second virtual subsidiary logical unit to the first subsidiary logical unit.

15. The method according to claim 10, wherein the storage system comprises a first virtual logical unit group having a first virtual administrative logical unit that is mapped to a first administrative logical unit of a first logical unit group that is mapped to a first logical volume of the plurality of logical volumes, and a second virtual logical unit group having a second virtual administrative logical unit that is mapped to a second administrative logical unit of a second logical unit group that is mapped to a second logical volume of the plurality of logical volumes, the second logical volume having a different storage function from the first logical volume; wherein the first virtual subsidiary logical unit has a first virtual subsidiary logical unit which is initially mapped to a first subsidiary logical unit of the first logical unit group; the method further comprising:
binding the first virtual subsidiary logical unit of the first virtual logical unit group to a second virtual subsidiary logical unit of the second virtual logical unit group;
migrating data of the first subsidiary logical unit to a third subsidiary logical unit of a third logical unit group which is mapped to a third logical volume of the plurality of logical volumes, the third logical volume having a same storage function as the first logical volume;
deleting mapping of the first virtual subsidiary logical unit to the first subsidiary logical unit; and
creating mapping of the second virtual subsidiary logical unit to the third subsidiary logical unit.

16. The method according to claim 10, wherein the storage system comprises a first virtual logical unit group having a first virtual administrative logical unit that is mapped to a first administrative logical unit of a first logical unit group that is mapped to a first logical volume of the plurality of logical volumes, and a second virtual logical unit group having a second virtual administrative logical unit that is mapped to a second administrative logical unit of a second logical unit group that is mapped to a second logical volume of the plurality of logical volumes, the second logical volume having a different storage function from the first logical volume; wherein the first virtual subsidiary logical unit has a first virtual subsidiary logical unit which is initially mapped to a first subsidiary logical unit of the first logical unit group; the method further comprising:
binding the first virtual subsidiary logical unit of the first virtual logical unit group to a second virtual subsidiary logical unit of the second virtual logical unit group;
migrating data of the first subsidiary logical unit to a second subsidiary logical unit of the second logical unit group;
deleting mapping of the first virtual subsidiary logical unit to the first subsidiary logical unit; and
creating mapping of the second virtual subsidiary logical unit to the second subsidiary logical unit.

17. The method according to claim 10, wherein the storage system comprises a first virtual logical unit group having a first virtual administrative logical unit that is mapped to a first administrative logical unit of a first logical unit group that is mapped to a first logical volume of the plurality of logical volumes; a second virtual logical unit group having a second virtual administrative logical unit that is mapped to a second administrative logical unit of a second logical unit group that is mapped to a second logical volume of the plurality of logical volumes, the second logical volume having a same storage function as the first logical volume; and a third virtual logical unit group having a third virtual administrative logical unit that is mapped to a third administrative logical unit of a third logical unit group that is mapped to a third logical volume of the plurality of logical volumes, the third logical volume having a different storage function from the first logical volume; wherein the first virtual subsidiary logical unit has a first virtual subsidiary logical unit which is initially mapped to a first subsidiary logical unit of the first logical unit group; the method further comprising:
performing local copy of data from the first subsidiary logical unit to the second subsidiary logical unit;
binding the first virtual subsidiary logical unit to the third virtual subsidiary logical unit;
setting up virtual local copy of data from the third virtual subsidiary logical unit to the second virtual subsidiary logical unit;
deleting mapping of the first virtual subsidiary logical unit to the first subsidiary logical unit; and
creating mapping of the second virtual subsidiary logical unit to the second subsidiary logical unit.

18. The method according to claim 10, further comprising:
managing a second logical unit group, which is mapped to a logical volume of an external storage system and includes a second administrative logical unit and one or more second subsidiary logical units, the logical volume of the external storage system being a unit for setting a storage function; and
mapping the virtual administrative logical unit to the second administrative logical unit.

19. A non-transitory computer-readable storage medium storing a plurality of instructions for controlling a data processor to apply storage functionality in a storage system which includes a plurality of storage devices to store data and a controller operable to manage a plurality of logical volumes, each of which is a unit for setting a storage function; the plurality of instructions comprising:
instructions that cause the data processor to manage a logical unit group, which is mapped to one of the logical volumes and includes an administrative logical unit and one or more subsidiary logical units; and
instructions that cause the data processor to manage a virtual logical unit group which includes a plurality of virtual subsidiary logical units and a virtual administrative logical unit that is mapped to the administrative logical unit, each of which is provided to one of a plurality of virtual machines of a server, at least one virtual subsidiary logical unit being mapped to the one or more subsidiary logical units.

20. The non-transitory computer-readable storage medium according to claim 19, wherein the plurality of virtual subsidiary logical units include a first virtual subsidiary logical unit and a second virtual subsidiary logical unit; the plurality of instructions further comprising:
instructions that cause the data processor to map the first virtual subsidiary logical unit to a first subsidiary logical unit of a first logical unit group that is mapped to a first logical volume of the plurality of logical volumes; and
instructions that cause the data processor to map the second virtual subsidiary logical unit to either a second subsidiary logical unit of a second logical unit group that is mapped to a second logical volume of the plurality of logical volumes or to another one of the plurality of logical volumes.
